(19) United States
(12) Patent Application Publication
(10) Pub. No.: US 2026/0343296 A1
(43) Pub. Date: Oct. 29, 2026

(54) TERMINAL, RADIO COMMUNICATION METHOD, AND BASE STATION

(71) Applicant: NTT DOCOMO, INC., Tokyo (JP)

(72) Inventors: Yuki Matsumura, Chiyoda-ku, Tokyo (JP); Mamoru Okumura, Chiyoda-ku, Tokyo (JP); Satoshi Nagata, Chiyoda-ku, Tokyo (JP); Jing Wang, Beijing (CN); Lan Chen, Beijing (CN)

(73) Assignee: NTT DOCOMO, INC., Tokyo (JP)

(21) Appl. No.: 19/471,568

(22) PCT Filed: Apr. 5, 2023
(86) PCT No.: PCT/JP2023/014070

§ 371 Date: Oct. 1, 2025

(51) Int. Cl. H04W 24/10

(52) U.S. Cl. CPC H04W 24/10

(57) ABSTRACT

A terminal according to one aspect of the present disclosure includes: a receiving section that receives information related to a candidate cell for which cell switching is supported by L1/L2 signaling; and a control section that controls measurement of the candidate cell, wherein one or a plurality of specific parameters are configured for at least one of intra-frequency measurement and inter-frequency measurement, for each candidate cell.

### TECHNICAL FIELD

The present disclosure relates to a terminal, a radio communication method, and a base station in next-generation mobile communication systems.

### BACKGROUND ART

In a Universal Mobile Telecommunications System (UMTS) network, the specifications of Long Term Evolution (LTE) have been drafted for the purpose of further increasing high speed data rates, providing lower latency and so on (Non-Patent Literature 1). In addition, for the purpose of further high capacity, advancement and the like of the LTE (Third Generation Partnership Project (3GPP (registered trademark)) Release (Rel.) 8 and Rel. 9), the specifications of LTE-Advanced (3GPP Rel. 10 to Rel. 14) have been drafted.

Successor systems of LTE (for example, also referred to as “5th generation mobile communication system (5G)”, “5G+(plus)”, “6th generation mobile communication system (6G)”, “New Radio (NR)”, “3GPP Rel. 15 (or later versions)”, and so on) are also under study.

### CITATION LIST

### Non-Patent Literature

Non-Patent Literature 1: 3GPP TS 36.300 V 8.12.0 “Evolved Universal Terrestrial Radio Access (E-UTRA) and Evolved Universal Terrestrial Radio Access Network (E-UTRAN); Overall description; Stage 2 (Release 8)”, April, 2010

### SUMMARY OF INVENTION

### Technical Problem

In future radio communication systems (for example, radio communication systems later than Rel. 18/5G), it is assumed to control communication using a plurality of transmission/reception points (for example, a multi-TRP (MTRP) in a serving cell or control communication based on mobility among a plurality of cells (inter-cell mobility) including a non-serving cell/intra-cell mobility (inter-cell mobility).

In Rel. 17, inter-cell beam management (inter-cell BM (ICBM)) is supported to support beam switching between a serving cell and a candidate cell having the same frequency. In Rel. 18 or later versions, it is assumed that L1/L2-triggered mobility (LTM) (for example, cell switching) is supported, and switching to a candidate cell corresponding to a frequency different from that of a serving cell is also assumed. It is also assumed that, when cell switching is performed, an operation of intra-frequency measurement/inter-frequency measurement is also performed.

In such a case, how to configure a parameter and the like configured for a candidate cell is not clear. It is not clear either how to perform control when simultaneous operations of a first operation of Rel. 17 or a previous version (for example, ICBM) and a second operation supported in Rel. 18 or later versions (for example, L1L2-triggered mobility (LTM)) is supported.

The present disclosure has been made in view of this respect, and has an object to provide a terminal, a radio communication method, and a base station that can appropriately perform communication even when cell switching is supported.

### Solution to Problem

A terminal according to one aspect of the present disclosure includes: a receiving section that receives information related to a candidate cell for which cell switching is supported by L1/L2 signaling; and a control section that controls measurement of the candidate cell, whereinone or a plurality of specific parameters are configured for at least one of intra-frequency measurement and inter-frequency measurement, for each candidate cell.

### Advantageous Effects of Invention

According to an aspect of the present disclosure, even when cell switching is supported, communication can be appropriately performed.

### BRIEF DESCRIPTION OF DRAWINGS

FIG. 1A to FIG. 1D are diagrams to show examples of multi-TRPs.

FIG. 2A and FIG. 2B are diagrams to show examples of inter-cell mobility.

FIG. 3A and FIG. 3B are diagrams to show examples of switching between a serving cell and an additional cell by L1/L2 signaling.

FIG. 4 is a diagram to show an example of configuration examples 1 to 3 when candidate cells are supported.

FIG. 5A to FIG. 5C are diagrams to show respective examples of a case where switching with candidate cells/a candidate cell group by L1/L2 signaling is performed in configuration examples 1 to 3 when candidate cells are supported.

FIG. 6 shows part of higher layer parameters (for example, IE SSB-MTC) used for configuring a timing occasion for a UE to measure an SSB.

FIG. 7 is a diagram to show an overview of L1L2-triggered mobility (LTM).

FIG. 8 is a diagram to show a PDCCH ordered RACH with random access response (RAR) monitoring, for a serving cell.

FIG. 9 is a diagram to show a PDCCH ordered RACH without random access response (RAR) monitoring, for a candidate cell(s).

FIG. 10 is a diagram to show an example of parameter configurations according to a first embodiment.

FIG. 11 is a diagram to show an example of a configuration of candidate cells corresponding to a first operation and a second operation according to a second embodiment.

FIG. 12 is a diagram to show another example of the configuration of candidate cells corresponding to the first operation and the second operation according to the second embodiment.

FIG. 13 is a diagram to show another example of the configuration of candidate cells corresponding to the first operation and the second operation according to the second embodiment.

FIG. 14 is a diagram to show an example of a schematic structure of a radio communication system according to one embodiment.

FIG. 15 is a diagram to show an example of a structure of a base station according to one embodiment.

FIG. 16 is a diagram to show an example of a structure of a user terminal according to one embodiment.

FIG. 17 is a diagram to show an example of a hardware structure of the base station and the user terminal according to one embodiment.

FIG. 18 is a diagram to show an example of a vehicle according to one embodiment.

### DESCRIPTION OF EMBODIMENTS

### TCI, Spatial Relation, QCL

For NR, control of reception processing (for example, at least one of reception, de-mapping, demodulation, and decoding) and transmission processing (for example, at least one of transmission, mapping, precoding, modulation, and coding) of at least one of a signal and a channel (referred to as a signal/channel) in a UE, based on a transmission configuration indication state (TCI state) has been under study.

The TCI state may be a state applied to a downlink signal/channel. A state that corresponds to the TCI state applied to an uplink signal/channel may be expressed as spatial relation.

The TCI state is information Related to Quasi-co-location (QCL) of the signal/channel, and may be referred to as a spatial reception parameter, spatial relation information, or the like. The TCI state may be configured for the UE for each channel or for each signal.

QCL is an indicator indicating statistical properties of the signal/channel. For example, when a certain signal/channel and another signal/channel are in a relationship of QCL, it may mean that it is assumable that at least one of Doppler shift, a Doppler spread, an average delay, a delay spread, and a spatial parameter (for example, a spatial reception parameter (spatial Rx parameter)) is the same (the relationship of QCL is satisfied in at least one of these) between the plurality of different signals/channels.

Note that the spatial reception parameter may correspond to a receive beam of the UE (for example, a receive analog beam), and the beam may be identified based on spatial QCL. The QCL (or at least one element in the relationship of QCL) in the present disclosure may be used interchangeably with sQCL (spatial QCL).

For the QCL, a plurality of types (QCL types) may be defined. For example, four QCL types A to D may be provided, which have different parameter(s) (or parameter set(s)) that can be assumed to be the same, and such parameter(s) (which may be referred to as QCL parameter(s)) are described below:
QCL type A (QCL-A): Doppler shift, Doppler spread, average delay, and delay spread
QCL type B (QCL-B): Doppler shift and Doppler spread
QCL type C (QCL-C): Doppler shift and average delay
QCL type D (QCL-D): Spatial reception parameter

A case that the UE assumes that a certain control resource set (CORESET), channel, or reference signal is in a relationship of specific QCL (for example, QCL type D) with another CORESET, channel, or reference signal may be referred to as QCL assumption.

The UE may determine at least one of a transmit beam (Tx beam) and a receive beam (Rx beam) of the signal/channel, based on the TCI state or the QCL assumption of the signal/channel.

The TCI state may be, for example, information related to QCL between a channel as a target (in other words, a reference signal (RS) for the channel) and another signal (for example, another RS). The TCI state may be configured (indicated) by higher layer signaling or physical layer signaling, or a combination of these.

Note that a channel/signal being a target of application of a TCI state may be referred to as a target channel/reference signal (RS) or simply as a target, and another signal described above may be referred to as a reference reference signal (reference RS), a source RS, or simply as a reference.

A channel for which the TCI state or spatial relation is configured (specified) may be, for example, at least one of a downlink shared channel (Physical Downlink Shared Channel (PDSCH)), a downlink control channel (Physical Downlink Control Channel (PDCCH)), an uplink shared channel (Physical Uplink Shared Channel (PUSCH)), and an uplink control channel (Physical Uplink Control Channel (PUCCH)).

The RS to have a QCL relationship with the channel may be, for example, at least one of a synchronization signal block (SSB), a channel state information reference signal (CSI-RS), a reference signal for measurement (Sounding Reference Signal (SRS)), a CSI-RS for tracking (also referred to as a Tracking Reference Signal (TRS)), a reference signal for QCL detection (also referred to as a QRS), a reference signal for demodulation (DeModulation Reference Signal (DMRS)), and the like.

The SSB is a signal block including at least one of a primary synchronization signal (PSS), a secondary synchronization signal (SSS), and a broadcast channel (Physical Broadcast Channel (PBCH)). The SSB may be referred to as an SS/PBCH block.

An RS of QCL type X in a TCI state may mean an RS in a relationship of QCL type X with (a DMRS of) a certain channel/signal, and this RS may be referred to as a QCL source of QCL type X in the TCI state.

### Multi-TRP

In NR, it is studied that one or a plurality of transmission/reception points (TRPs) (multi-TRP) perform DL transmission to a UE by using one or a plurality of panels (multi-panel). It is also studied that the UE performs UL transmission to the one or plurality of TRPs.

Note that the plurality of TRPs may correspond to the same cell identifier (ID) or may correspond to different cell IDs. The cell ID may be a physical cell ID (for example, a PCI), or may be a virtual cell ID.

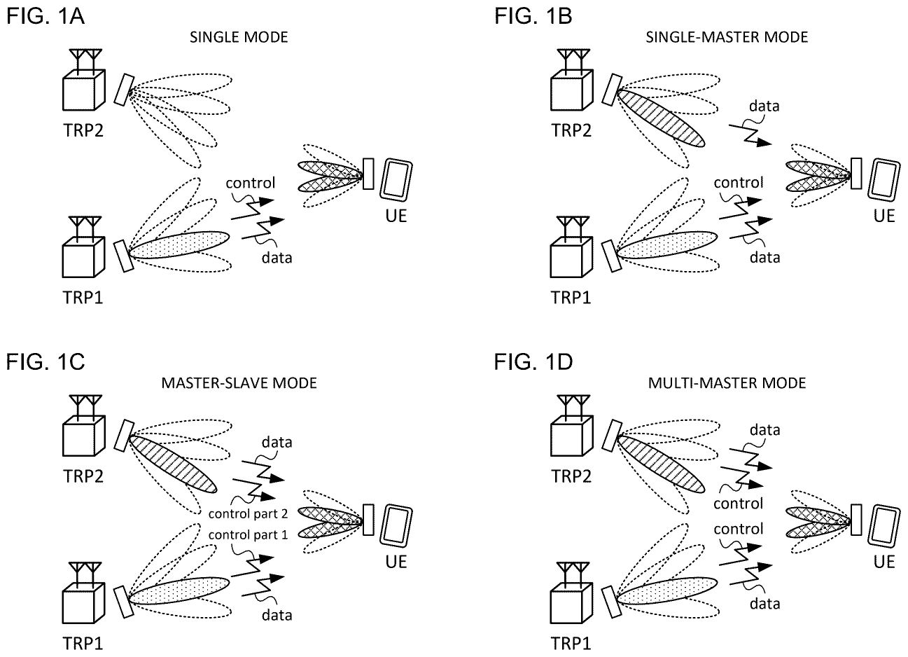

FIG. 1A to FIG. 1D are diagrams to show examples of multi-TRP scenarios. In these examples, it is assumed that each TRP can transmit four different beams; however, this is not restrictive.

FIG. 1A shows an example of a case (which may be referred to as a single mode, a single TRP, or the like) in which only one TRP (in the present example, TRP1) out of the multi-TRP performs transmission to the UE. In this case, TRP1 transmits both of a control signal (PDCCH) and a data signal (PDSCH) to the UE.

In the present disclosure, a single-TRP mode may mean a mode when the multi-TRP (mode) is not configured.

FIG. 1B shows an example of a case (which may be referred to as a single master mode) in which only one TRP (in the present example, TRP1) out of the multi-TRP transmits a control signal to the UE, and the multi-TRP transmits a data signal thereto. The UE receives the PDSCHs transmitted from the multi-TRP, based on one piece of downlink control information (DCI).

FIG. 1C shows an example of a case (which may be referred to as a master slave mode) in which each of the multi-TRP transmits a part of a control signal to the UE, and the multi-TRP transmits a data signal thereto. In TRP1, part 1 of the control signal (DCI) may be transmitted, and in TRP2, part 2 of the control signal (DCI) may be transmitted. Part 2 of the control signal may be dependent upon part 1. The UE receives the PDSCHs transmitted from the multi-TRP, based on these parts of the DCI.

FIG. 1D shows an example of a case (which may be referred to as a multi-master mode) in which each of the multi-TRP transmits a different control signal to the UE, and the multi-TRP transmits a data signal thereto. In TRP1, a first control signal (DCI) may be transmitted, and in TRP2, a second control signal (DCI) may be transmitted. The UE receives the PDSCHs transmitted from the multi-TRP, based on these DCIs.

When a plurality of PDSCHs (which may be referred to as multi-PDSCH (multiple PDSCHs)) from the multi-TRP as shown in FIG. 1B are scheduled using one DCI, the DCI may be referred to as single DCI (S-DCI, single PDCCH). When a plurality of PDSCHs from the multi-TRP as shown in FIG. 1D are respectively scheduled using a plurality of DCIs, the plurality of DCIs may be referred to as multi-DCI (M-DCI, multi-PDCCH (multiple PDCCHs)).

From each TRP of the multi-TRP, different transport blocks (TBs)/codewords (Code Words (CWs))/different layers may be transmitted. Alternatively, from each TRP of the multi-TRP, the same TB/CW/layer may be transmitted.

As one mode of multi-TRP transmission, non-coherent joint transmission (NCJT) has been under study. In NCJT, for example, TRP1 performs modulation mapping and then layer mapping on a first codeword so as to transmit a first PDSCH by using first precoding for a first number of layers (for example, two layers). TRP2 performs modulation mapping and then layer mapping on a second codeword so as to transmit a second PDSCH by using second precoding for a second number of layers (for example, two layers).

Note that it may be defined that a plurality of PDSCHs (multi-PDSCH) to be transmitted using NCJT partially or entirely overlap in at least one of the time and frequency domains. In other words, at least one of the time and frequency resources of the first PDSCH from the first TRP and the second PDSCH from the second TRP may overlap.

It may be assumed that the first PDSCH and the second PDSCH are not in a quasi-co-location (QCL) relationship (not quasi-co-located). Reception of the multi-PDSCH may be used interchangeably with simultaneous reception of PDSCHs that are not of a certain QCL type (for example, QCL type D).

In URLLC for the multi-TRP, support of PDSCH (transport block (TB) or codeword (CW)) repetition across the multi-TRP has been under study. Support of repetition schemes across the multi-TRP (URLLC schemes, for example, schemes 1, 2a, 2b, 3, and 4) in the frequency domain, the layer (spatial) domain, or the time domain has been under study. In scheme 1, the multi-PDSCH from the multi-TRP is subjected to space division multiplexing (SDM). In schemes 2a and 2b, the PDSCH from the multi-TRP is subjected to frequency division multiplexing (FDM). In scheme 2a, a redundancy version (RV) is the same for the multi-TRP. In scheme 2b, the RV may be the same or may be different for the multi-TRP. In schemes 3 and 4, the multi-PDSCH from the multi-TRP is subjected to time division multiplexing (TDM). In scheme 3, the multi-PDSCH from the multi-TRP is transmitted in one slot. In scheme 4, the multi-PDSCH from the multi-TRP is transmitted in different slots.

According to the multi-TRP scenario as described above, more flexible transmission control using a channel with satisfactory quality can be performed.

NCJT using multi-TRP/panel may use a high rank. In order to support ideal and non-ideal backhauls among multiple TRPs, both of the single DCI (single PDCCH, for example, FIG. 1B) and the multi-DCI (multi-PDCCH, for example, FIG. 1D) may be supported. For both of the single DCI and the multi-DCI, the maximum number of TRPs may be 2.

For single PDCCH design (mainly for the ideal backhaul), enhancement of the TCI has been under study. Each TCI code point in the DCI may correspond to one or two TCI states. A TCI field size may be the same as that of Rel. 15.

Regarding the PDCCH/CORESET defined in Rel. 15, one TCI state without a CORESET pool index (CORESETPoolIndex) (which may be referred to as TRP information (TRP Info)) is configured for one CORESET.

Regarding enhancement of the PDCCH/CORESET defined in Rel. 16, the CORESET pool index is configured for each CORESET in the multi-TRP based on the multi-DCI.

### Inter-Cell Mobility

For NR, it is studied that one or a plurality of transmission/reception points (TRPs) (multi-TRP (MTRP)) perform DL transmission to a UE. It is also studied that the UE performs UL transmission to the one or plurality of TRPs.

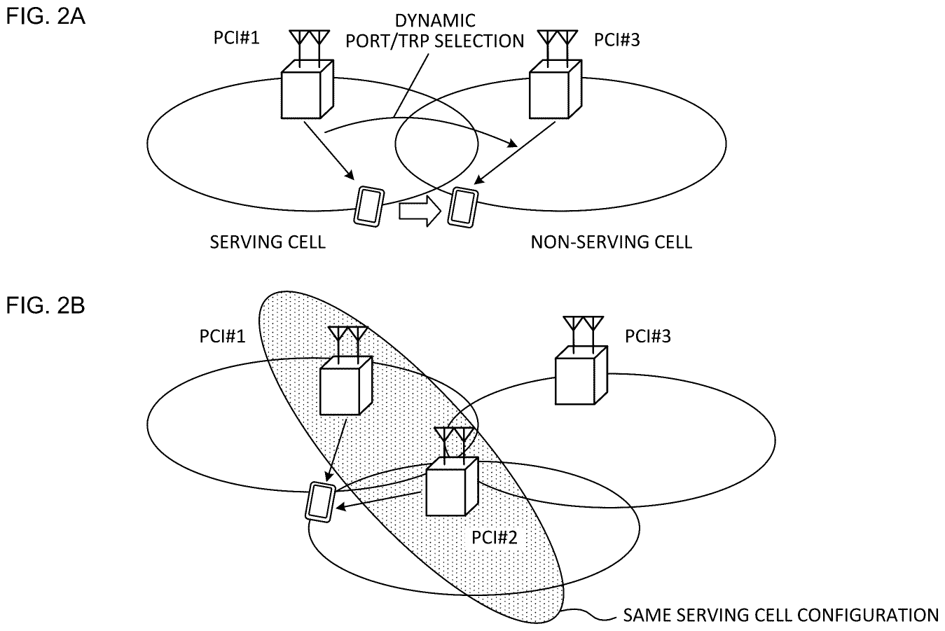

It is considered that a UE receives channels/signals from a plurality of cells/TRPs in inter-cell mobility (for example, L1/L2 inter cell mobility) (see FIGS. 2A and 2B).

FIG. 2A shows an example of inter-cell mobility with cells including a non-serving cell (for example, Single-TRP inter-cell mobility). A UE may be configured with one TRP (or a single TRP) in each cell. Here, shown is a case where the UE receives channels/signals from a base station/TRP of cell #1 being a serving cell, and a base station/TRP of cell #3 being not a serving cell (non-serving cell). For example, this corresponds to a case where the UE switches from cell #1 to cell #3 (for example, fast cell switch).

In this case, selection of a port (for example, an antenna port) /TRP may be performed dynamically. The selection of a port (for example, an antenna port) /TRP may be performed based on a TCI state indicated or updated by DCI/MAC CE. Here, shown is a case of supporting configuration of different physical cell IDs (for example, PCIs) for cell #1 and cell #3.

FIG. 2B shows an example of a multi-TRP scenario (for example, inter-cell mobility in a case of using multi-TRP (Multi-TRP inter-cell mobility)). A UE may be configured with a plurality of (for example, two) TRPs (or different CORESET pool indices) in each cell. Here, shown is a case where the UE receives channels/signals from TRP #1 and TRP 2. Here, also shown is a case where TRP #1 corresponds to physical cell ID (PCI) #1 and TRP #2 corresponds to PCI #2.

The multi-TRP (for example, TRPs #1 and #2) may be connected via ideal/non-ideal backhaul to exchange information, data, and the like. Each TRP of the multi-TRP may transmit the same or a different codeword (Code Word (CW)) and the same or a different layer. As one mode of multi-TRP transmission, non-coherent joint transmission (NCJT) may be employed as shown in FIG. 2B. Here, shown is a case where NCJT is performed between TRPs corresponding to different PCIs. Note that the same serving cell configuration may be applied/configured for TRP #1 and TRP #2.

It may be defined that a plurality of PDSCHs (multi-PDSCH) subjected to NCJT partially or completely overlap with respect to at least one of time and frequency domains. In other words, a first PDSCH from TRP #1 and a second PDSCH from TRP #2 may overlap in terms of at least one of time and frequency resources. The first PDSCH and the second PDSCH may be used for transmission of the same TB or may be used for transmission of different TBs.

It may be assumed that the first PDSCH and the second PDSCH are not in a quasi-co-location (QCL) relationship (not quasi-co-located). Reception of the multi-PDSCH may be used interchangeably with simultaneous reception of PDSCHs that are not of a certain QCL type (for example, QCL type D).

A plurality of PDSCHs (which may be referred to as multi-PDSCH (multiple PDSCHs)) from the multi-TRP may be scheduled by using one piece of DCI (single DCI (S-DCI, single PDCCH)) (single-master mode). The one piece of DCI may be transmitted from one TRP of the multi-TRP. A structure using one piece of DCI in multi-TRP may be referred to as single-DCI based multi-TRP (mTRP/MTRP).

The plurality of PDSCHs from the multi-TRP may be scheduled by using a plurality of respective pieces of DCI (multi-DCI (MDCI), multi-PDCCH (multiple PDCCHs)). The plurality of pieces of DCI may be transmitted from respective TRPs of the multi-TRP. A structure using a plurality of pieces of DCI in multi-TRP may be referred to as multi-DCI based multi-TRP (mTRP/MTRP).

The UE may assume to transmit, to the different TRPs, separate CSI reports related to the respective TRPs. Such CSI feedback may be referred to as separate feedback, separate CSI feedback, and the like. In the present disclosure, “separate” may be used interchangeably with “independent.”

In inter-cell mobility, the following scenario 1 or scenario 2 is considered. Note that, in the present disclosure, a serving cell may be used interchangeably with a TRP in the serving cell. Layer 1/layer 2 (L1/L2) and DCI/Medium Access Control Control Element (MAC CE) may be interchangeably interpreted. In the present disclosure, a physical cell ID (Physical Cell Identity (PCI)) different from the PCI of the current serving cell may be simply referred to as a “different PCI.” A non-serving cell, a cell having a different PCI, a candidate cell, and an additional cell may be interchangeably interpreted.

### Scenario 1

Scenario 1 corresponds to inter-cell mobility (or inter-cell beam management) of multi-TRP, for example. Note that scenario 1 may be a scenario not corresponding to inter-cell mobility of the multi-TRP. In scenario 1, for example, the following procedure is performed.
(1) The UE receives, from the serving cell, a configuration of an SSB for beam measurement of a TRP corresponding to a different PCI from the serving cell and a configuration necessary for using radio resources for data transmission and reception, including resources of the different PCI.
(2) The UE performs beam measurement of the TRP corresponding to the different PCI, and reports beam measurement results to the serving cell.
(3) Based on the above report, the transmission configuration indication (TCI) state associated with the TRP corresponding to the different PCI is activated by L1/L2 signaling from the serving cell.
(4) The UE performs transmission and reception by using a UE-dedicated channel on the TRP corresponding to the different PCI.
(5) The UE needs to invariably cover the serving cell, including a case of the multi-TRP. Similarly to a conventional system, the UE needs to use a common channel (a broadcast control channel (BCCH), a paging channel (PCH)) and the like from the serving cell.

In scenario 1, when the UE transmits and receives an additional cell/TRP (a TRP corresponding to a PCI of the additional cell) and a signal, the serving cell (assumption of the serving cell in the UE) is not changed. In other words, switching of the serving cells by L1/L2 is not supported. The UE is configured with a higher layer parameter related to the PCI of the non-serving cell from the serving cell. Scenario 1 may be applied in Rel. 17, for example.

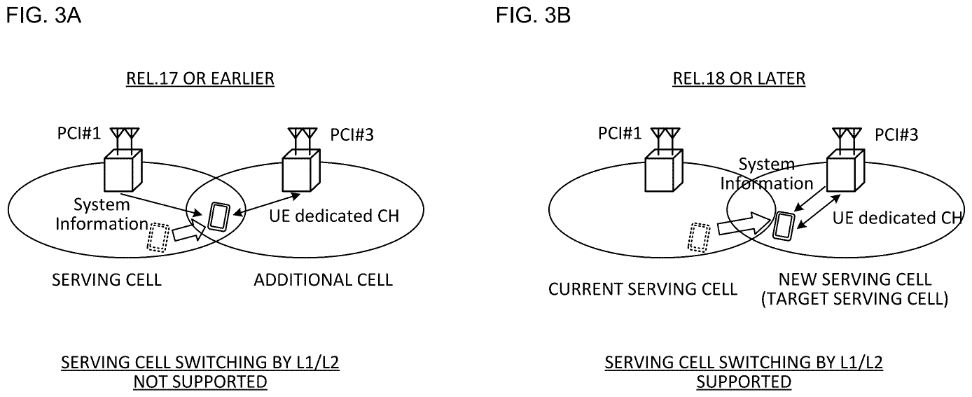

FIG. 3A is a diagram to show an example of movement of the UE in Rel. 17. A case is assumed in which the UE moves from a cell (serving cell) of PCI #1 to a cell (additional cell) (overlapping the serving cell) of PCI #3. In this case, in Rel. 17, switching of the serving cells by L1/L2 is not supported.

The additional cell is a cell having an additional PCI different from the PCI of the serving cell. The UE can receive/transmit a UE-dedicated channel from the additional cell. The UE needs to be present within coverage of the serving cell in order to receive a UE common channel (for example, system information/paging/short message). When the UE moves out of coverage of the serving cell, switching of cells is required through handover (also referred to as L3 mobility) or the like.

### Scenario 2

In scenario 2, L1/L2 inter-cell mobility is applied. In L1/L2 inter-cell mobility, the serving cell can be changed by using a function such as beam control without performing RRC reconfiguration. In other words, transmission and reception to and from an additional cell can be performed without performing handover (or without performing an L3 mobility procedure). For handover, RRC reconnection is required, which generates a period in which data communication cannot be performed, and thus by applying L1/L2 inter-cell mobility that does not require handover, data communication can be continued even at the time of the serving cell change. In scenario 2, for example, the following procedure is performed.
(1) The UE receives, from the serving cell, a configuration of an SSB for a cell (additional cell) having a different PCI for beam measurement/serving cell change.
(2) The UE performs beam measurement of the cell using the different PCI, and reports measurement results to the serving cell.
(3) The UE may receive a configuration (serving cell configuration) of the cell having the different PCI by higher layer signaling (for example, RRC). In other words, a pre-configuration related to serving cell change may be performed. The configuration may be performed together with or may be performed separately from the configuration in (1).
(4) Based on the above report, the TCI state of the cell having the different PCI may be activated by L1/L2 signaling according to the serving cell change. The TCI state activation and the serving cell change may be separately performed.
(5) The UE changes the serving cell (assumption of the serving cell), and starts reception/transmission by using a pre-configured UE-dedicated channel and the TCI state.

In other words, in scenario 2, the serving cell (assumption of the serving cell in the UE) is updated by L1/L2 signaling. Scenario 2 may be applied in Rel. 18 or later versions.

FIG. 3B is a diagram to show an example of movement of the UE in Rel. 18. In Rel. 18, the serving cell is switched by L1/L2 (for example, DCI/MAC CE). The UE can receive/transmit a UE-dedicated channel/common channel from/to a new serving cell (or a target serving cell). The UE may go out of the coverage of the current serving cell.

### Configuration of Candidate Cells

In L1/L2 inter-cell mobility, in addition to a serving cell (which may be referred to as a current serving cell), candidate cells may be configured. In the present disclosure, the candidate cells may be used interchangeably with target cells, target serving cells, additional cells, and additional PCIs.

A current serving cell and a target serving cell together may be referred to as candidate cells. In this case, for example, a serving cell may be used interchangeably with a current serving cell, and a candidate cell may be used interchangeably with a target serving cell.

One or more candidate cells (or a candidate cell group) may be separately associated with respective serving cells, or one or more candidate cells (or a candidate cell group) may be associated with a plurality of serving cells in common.

Configuration of candidate cells (or a candidate cell group) may be configured similarly to inter-cell beam management (inter-cell BM (ICBM)) of existing systems (for example, Rel. 17 or earlier versions) by using a given higher layer parameter (for example, ServingCellConfig). Alternatively, for configuration of candidate cells (or a candidate cell group), a framework for carrier aggregation configuration (for example, CA configuration framework) or a framework for CHO (Conditional Handover)/CPC (Conditional PSCell Change) configuration may be reused.

In Rel-17 inter-cell beam management, it is supported that up to eight TCI states are activated by a MAC CE, and part of the TCI states are associated with additional PCIs. Note that this is limited to the same frequency as a frequency of a serving cell.

Regarding candidate cells (or a candidate cell group) configured by a higher layer parameter, activation/deactivation may be indicated to the UE by a MAC CE/DCI.

As configuration of candidate cells (or association with serving cells), for example, at least one of the following configuration example 1 to configuration example 3 may be applied. Here, shown is an example of SpCell #0, SCell #1, and SCell #2 being configured as serving cells and candidate cells/a candidate cell group being configured separately from the serving cells. The following configuration example 1 to configuration example 3 are an example, and the number of serving cells/the number of candidate cells/the number of candidate cell groups, association between the serving cells and the candidate cells, and the like are not limited to this and may be changed as appropriate. Alternatively, another configuration example(s) may be supported/employed in addition to/instead of configuration example 1 to configuration example 3.

### Configuration Example 1

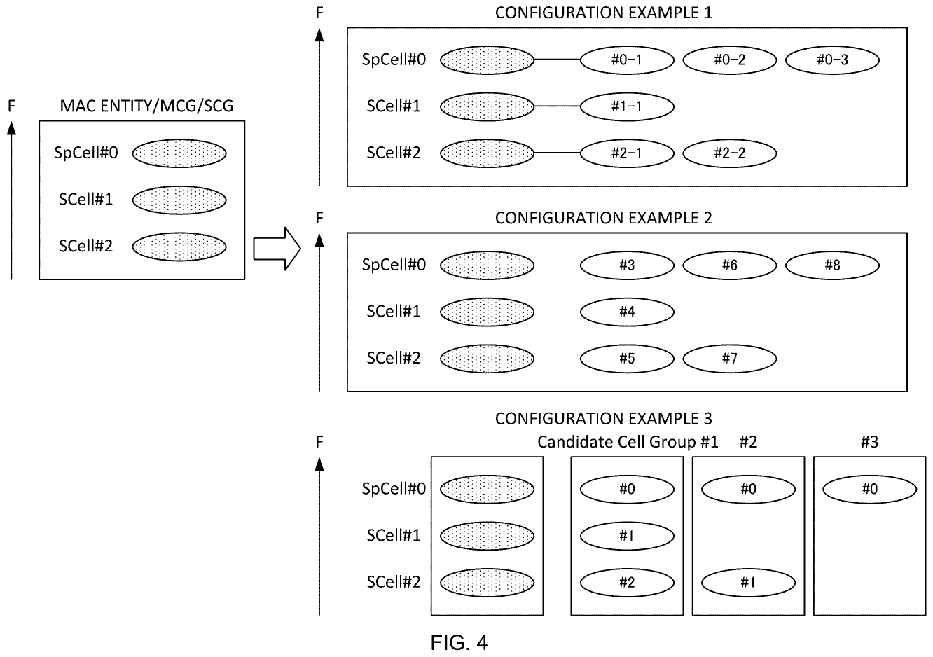

In configuration example 1, one or more candidate cells are respectively associated with/configured for each serving cell (or a frequency domain corresponding to each serving cell) (see FIG. 4). Here, shown is a case where candidate cells #0-1, #0-2, and #0-3 are associated with SpCell #0 (or a frequency domain corresponding to SpCell #0), candidate cell #1-1 is associated with SCell #1 (or a frequency domain corresponding to SCell #1), and candidate cells #2-1 and #2-2 are associated with SCell #2 (or a frequency domain corresponding to SpCell #2). Information related to the association may be configured/indicated from the base station to the UE by RRC/MAC CE/DCI.

### Configuration Example 2

In configuration example 2, candidate cells are associated with/configured for a MAC entity/MCG/SCG (see FIG. 4). Here, shown is a case where candidate cells #3 to #8 are associated with a MAC entity/MCG/SCG. In this case, instead of a candidate cell(s) being associated with each serving cell, the candidate cells are configured for the MAC entity or cell group (for example, an MCG/SCG). Information related to the candidate cell(s) configured for each cell may be configured/indicated by the base station to the UE by RRC/MAC CE/DCI.

### Configuration Example 3

In configuration example 3, one or more candidate cell groups are configured (see FIG. 4). Each candidate cell group includes one or more candidate cells. Here, shown is a case where candidate cell group #1 including candidate cells #0 to #2, candidate cell group #2 including candidate cells #0 and #1, and candidate cell group #3 including candidate cell #0 are configured. At least one of information related to the candidate cell groups to be configured and information related to the candidate cell(s) included in each candidate cell group may be configured/indicated from the base station to the UE by RRC/MAC CE/DCI.

### Serving Cell Switching

In existing systems (for example, Rel. 17), L1 beam indication for a TCI state of an additional PCI (or an additional cell) (for example, indication by a TCI state field of DCI) is supported.

It is assumed, in Rel. 18 or later versions, that a new L1/L2 signal (for example, DCI/MAC CE) indicating switching of a serving cell (for example, serving cell switch) is supported. It may be assumed that, as the indication, at least one of implicit indication and explicit indication is supported. The implicit indication may mean that a certain CORESET is updated to a TCI state associated with an additional PCI by a MAC CE, for example. The explicit indication may mean that cell switching is directly indicated by DCI/MAC CE.

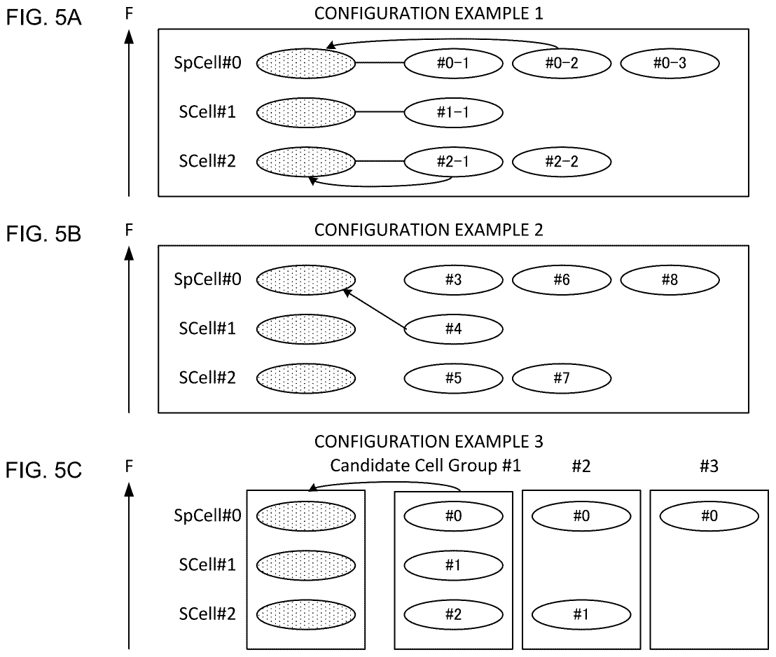

For example, in configuration example 1 of candidate cells, a given candidate cell may be specified as a serving cell (or indicated for switching with a serving cell) via L1/L2 signaling. FIG. 5A shows a case where candidate cell #0-2 turns to be an SpCell of the MCG/SCG (SpCell #0 and candidate cell #0-2 are switched) by L1/L2 signaling. Also shown is a case where candidate cell #2-1 turns to be an SCell of an MCG/SCG (SCell #2 and candidate cell #2-1 are switched) by L1/L2 signaling.

Alternatively, in configuration example 2 of candidate cells, a given candidate cell may be specified as a serving cell (or indicated for switching with a serving cell) via L1/L2 signaling. FIG. 5B shows a case where candidate cell #4 turns to be an SpCell of an MCG/SCG (SpCell #0 and candidate cell #4 are switched) by L1/L2 signaling.

Alternatively, in configuration example 3 of candidate cells, a given candidate cell group (or one or more candidate cells included in the given candidate cell group) may be changed/updated to a serving cell group via L1/L2 signaling. FIG. 5C shows a case where candidate cell group #1 (or candidate cells #0 to #2 included in candidate cell group #1) turns to be a serving cell group (or the serving cell group and candidate cell group #1 are switched) by L1/L2 signaling. Of the candidate cells (here, candidate cells #0 to #2) included in candidate cell group #1, the candidate cell associated with SpCell #0 or the candidate cell (here, candidate cell #0) configured for the same frequency domain as that of SpCell #0 may be configured as a new SpCell. Alternatively, the candidate cell to turn to be the SpCell may be indicated by L1/L2 signaling.

### Inter-Cell Beam Management

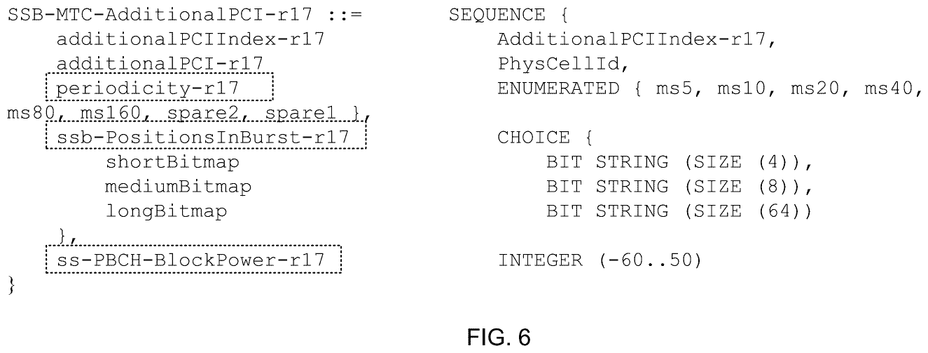

In Rel-17 inter-cell beam management (ICBM), candidate cells are configured for the same frequency as a frequency of the serving cell, and parameters of SSB periodicity (for example, periodicity), SSB position (for example, ssb-PositionsInBurst), and SSB power (for example, ss-PBCH-BlockPower) are configured for the candidate cells (see FIG. 6). FIG. 6 shows part of higher layer parameters (for example, IE SSB-MTC) used for configuring a timing occasion for a UE to measure an SSB.

Meanwhile, no configuration may be made for the center frequency (for example, enter frequency) , subcarrier spacing (SCS), and a system frame number offset (for example, an SFN offset) of the SSB, and the same configuration as that of the serving cell may be used. The UE may assume that an SSB from the serving cell and an SSB having a PCI different from the serving cell have the same center frequency, SCS, and SFN offset.

### Overview of L1L2-Triggered Mobility (LTM)

In Rel. 18 or later versions, it is assumed that mobility using trigger by L1/L2 (L1L2-triggered mobility (LTM)) is supported.

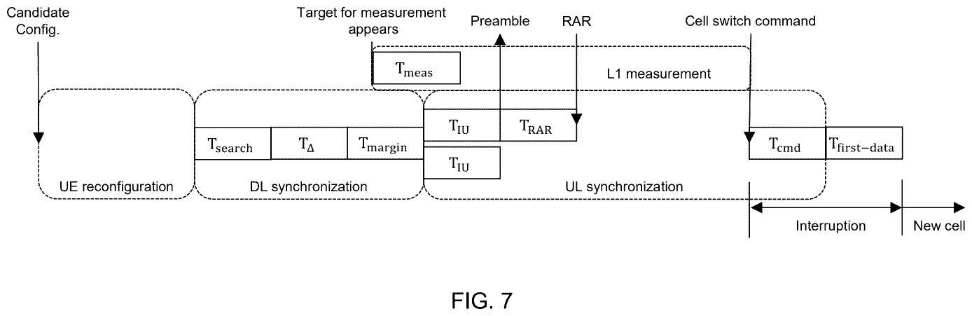

FIG. 7 is a diagram to show an overview of L1L2-triggered mobility (LTM). LTM and L1/L2 inter-cell mobility may be interchangeably interpreted. In UE reconfiguration, a UE receives candidate cell configurations related to candidate cells from an NW. Information related to a candidate cell may include information related to a target serving cell, or information related to a target serving cell and information related to the current serving cell.

The UE reconfiguration includes T_{RRC} and T_{processing1/Tprocessing2}. T_{RRC} (for example, 10 ms at maximum) denotes processing time for RRC reconfiguration for transmitting candidate cell configurations (candidate configurations). T_{processing1/Tprocessing2} (for example, 20 ms at maximum for the same FR, 40 ms at maximum for different FRs) denotes respective times for UE processing before and after cell switching command. This includes L2/3 reconfiguration, RF retuning, baseband retuning, security update if necessary, and the like in some cases.

DL synchronization includes T_{search}, T_{Δ}, and T_{margin}. T_{search} (for example, 0 ms when a cell is known, 60 ms at maximum when a cell is unknown) is a time required for searching for a target cell. T_{Δ} is a time for detailed tracking and acquisition of pieces of timing information. T_{margin} (for example, 2 ms at maximum) is a time for post-processing of the SSB and a CSI-RS.

L1 measurement includes Tₘₑₐₛ (SMTC periodicity (for example, 20 ms)). Tₘₑₐₛ denotes measurement delay from appearance of a target to cell switching command.

UL synchronization includes T_{IU}, T_{RAR}, and T_{cmd}. T_{IU} (for example, 15 ms at maximum) denotes an uncertain interruption time for acquiring a PRACH occasion available first in a new cell. T_{RAR} (for example, 4 ms at maximum) is a time for RAR delay. T_{cmd} (for example, 5 ms at maximum) is a processing time for an L1/L2 command (HARQ and paging).

T_{first-data} after T_{cmd} denotes a time for a UE to perform, after RAR, first DL reception/UL transmission in an indication beam of a target cell.

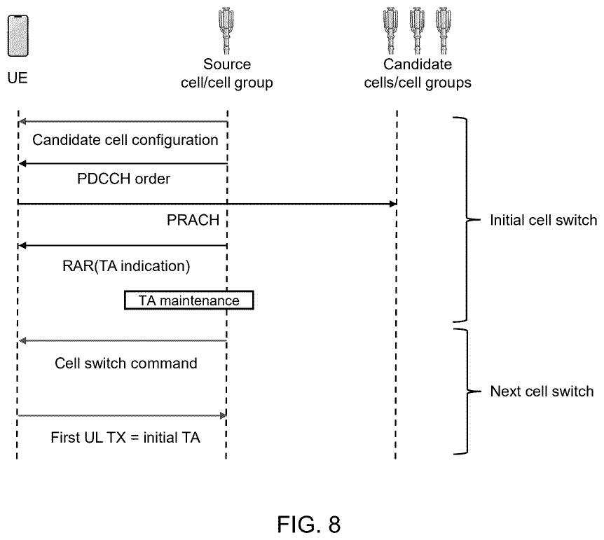

FIG. 8 is a diagram to show a PDCCH ordered RACH with random access response (RAR) monitoring, for a serving cell. Note that, in the present disclosure, a source cell and a source cell group may be interchangeably interpreted. A candidate cell and a candidate cell group may be interchangeably interpreted.

A source cell transmits a candidate cell configuration to a UE. The source cell then transmits a PDCCH (for example, including DCI format 1_0) order for a RACH to the UE. Note that one candidate cell is indicated by the order since parallel RAR is complicated. The UE then transmits a PRACH in a RACH procedure to the candidate cell for acquisition of TAG/TA.

Next, the source cell transmits a RAR (TA indication) to the UE. In this case, only one common search space (CSS) is configured, and hence, the RAR is monitored in an SpCell (only in a Distributed Unit (DU)). The UE may then perform transmission and reception in the current serving cell. Then, TA maintenance is performed in the source cell.

Next, the source cell transmits a cell switch command to the UE. At this stage, TA information can be moved from the source cell to the target cell. In this case, after the first cell switch, UL synchronization of all candidate cells may not be completed yet. The UE uses initial TA to perform the first UL transmission.

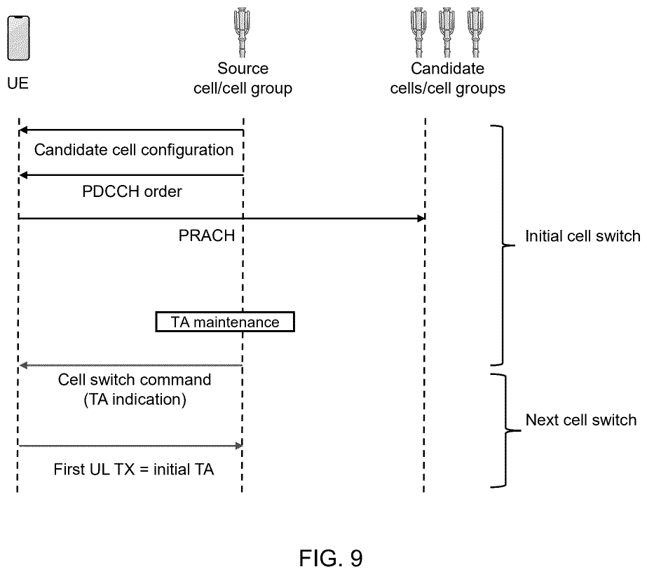

FIG. 9 is a diagram to show a PDCCH ordered RACH without random access response (RAR) monitoring, for a candidate cell(s). Only respects of FIG. 9 different from those of FIG. 8 will be described. In the example in FIG. 9, a PDCCH order for a RACH may indicate a plurality of candidate cells. The UE may transmit a PRACH in a RACH procedure to the plurality of candidate cells for acquisition of a plurality of TAGs/TAs. The source cell then transmits a TA indication in a cell switch command without transmitting a RAR.

In the present disclosure, a RACH without RAR may be used interchangeably with a RACH without RAR monitoring. A RACH may be used interchangeably with PRACH transmission triggered by a PDCCH order. A RACH procedure/PRACH transmission without RAR monitoring may be used interchangeably with a RACH procedure/PRACH transmission with no need of RAR monitoring or a RACH procedure/PRACH transmission for which RAR monitoring is not required.

For LTM, each candidate cell configuration may include at least a higher layer parameter CellGroupConfig and a configuration ID.

In LTM, the candidate cell configuration supports being a delta configuration corresponding to the top of reference configurations. Here, for the delta configuration, a UE stores a reference configuration as another configuration. In other words, reference configurations may be managed separately. For example, another reference configuration may be provided for the delta configuration of the candidate cell.

A MAC CE including LTM related information for cell switching may be used as trigger of LTM cell switching. LTM cell switching may be monitored by a timer. To indicate connection to a target cell, a MAC CE for cell switching command may be used.

In LTM, a target cell (PCell/SCell) may be the current SCell/PCell. In other words, the current SCell/PCell (serving cell) may be configured as a candidate cell.

In Rel-18 LTM, SSB-based measurement (for example, L1-RSRP measurement) may be supported. In this case, it is assumed that a given configuration parameter is applied/configured for a candidate cell.

For example, for intra-frequency measurement (for example, intra-F measurement), a physical cell ID (PCI) or a logical ID, and a time domain may be configured. To the PCI or the logical ID, an ID defined in Rel-17 inter-cell beam management (ICBM) may be applied. The time domain may be SMTC or periodicity and SSB position in burst, for example.

For inter-frequency measurement (for example, inter-F measurement), a physical cell ID (PCI) or a logical ID, a time domain, a frequency domain location, and subcarrier spacing (SCS) may be configured. To the PCI or the logical ID, an ID defined in Rel-17 inter-cell beam management (ICBM) may be applied. The time domain may be SMTC or periodicity and SSB position in burst, for example. The frequency domain location may be the center frequency.

In Rel-18 or later-version LTM, each candidate cell configuration may be provided by a given higher layer parameter. The given higher layer parameter may be a higher layer parameter related to a cell group configuration (for example, CellGroupConfig IE), for example.

### Analysis

In Rel-18 or later-version LTM, the possibility that a configuration parameter necessary for a candidate cell is different from that of Rel-17 inter-cell beam management (ICBM) (even in a case of intra-frequency measurement) is also considered.

This is because some parameters from a candidate cell need to be the same as those of the serving cell in Rel-17 ICBM to enable dynamic data scheduling only by changing the TCI state of the candidate cell.

In Rel-18 LTM, to support L1/L2 mobility between cells having different configurations and support more flexible NW development, relaxing of restrictions on candidate cells is also assumed.

For candidate cells having the same frequency as a frequency of the serving cell, a given restriction is needed for a candidate cell capable of performing Rel-17 ICBM. The given restriction may be a restriction of having the same center frequency, SCS, and SFN offset as those of the serving cell, for example. In Rel. 18 or later versions, it is also assumed that both Rel-17 ICBM and LTM are supported (for example, operated/applied simultaneously). In this case, how to control (for example, how to configure/enable) simultaneous operations of Rel-17 ICBM and Rel-18 LTM is a problem.

Hence, the inventors of the present invention studied configuration parameters necessary for a candidate cell (target serving cell/current serving cell) and came up with the idea of one aspect of the present embodiment. The inventors of the present invention also focused on a case where a first operation (for example, ICBM) and a second operation (for example, LTM) are supported simultaneously, studied a configuration of a candidate cell of this case, and came up with the idea of one aspect of the present embodiment.

In the present disclosure, candidate cells may include a target serving cell, or a target serving cell and a current serving cell.

Embodiments according to the present disclosure will be described in detail with reference to the drawings as follows. The radio communication methods according to respective embodiments may each be employed individually, or may be employed in combination.

### Various Interpretations and So On

In the present disclosure, “A/B” and “at least one of A and B” may be interchangeably interpreted. In the present disclosure, “A/B/C” may mean “at least one of A, B, and C.”

In the present disclosure, activate, deactivate, indicate, select, configure, update, determine, and the like may be interchangeably interpreted. In the present disclosure, “support”, “control”, “controllable”, “operate”, “operable”, and the like may be interchangeably interpreted.

In the present disclosure, radio resource control (RRC), an RRC parameter, an RRC message, a higher layer parameter, an information element (IE), a configuration, and the like may be interchangeably interpreted. In the present disclosure, a Medium Access Control control element (MAC Control Element (CE)), an update command, an activation/deactivation command, and the like may be interchangeably interpreted.

In the present disclosure, higher layer signaling may be, for example, any one or combinations of Radio Resource Control (RRC) signaling, Medium Access Control (MAC) signaling, broadcast information, other messages (for example, a message from a core network such as a protocol for positioning (for example, NR Positioning Protocol A (NRPPa)/LTE Positioning Protocol (LPP) message)) and the like.

In the present disclosure, the MAC signaling may use, for example, a MAC control element (MAC CE), a MAC Protocol Data Unit (PDU), or the like. The broadcast information may be, for example, a master information block (MIB), a system information block (SIB), minimum system information (Remaining Minimum System Information (RMSI)), other system information (OSI), or the like.

In the present disclosure, the physical layer signaling may be, for example, downlink control information (DCI), uplink control information (UCI), or the like.

In the following embodiments, a “plurality of” and “two” may be interchangeably interpreted. A “TAG” and a “TAG ID” may be interchangeably interpreted. A “cell”, a “CC”, and a “carrier” may be interchangeably interpreted. In the following embodiments, “calculation”, “computation”, and “acquisition” may be interchangeably interpreted.

In the present disclosure, an index, an identifier (ID), an indicator, a resource ID, and the like may be interchangeably interpreted. In the present disclosure, a sequence, a list, a set, a group, a cluster, a subset, and the like may be interchangeably interpreted.

In the present disclosure, a panel, a UE panel, a panel group, a beam, a beam group, a precoder, an Uplink (UL) transmission entity, a transmission/reception point (TRP), a base station, spatial relation information (SRI), a spatial relation, an SRS resource indicator (SRI), a control resource set (CORESET), a Physical Downlink Shared Channel (PDSCH), a codeword (CW), a transport block (TB), a reference signal (RS), an antenna port (for example, a demodulation reference signal (DMRS) port), an antenna port group (for example, a DMRS port group), a group (for example, a spatial relation group, a code division multiplexing (CDM) group, a reference signal group, a CORESET group, a Physical Uplink Control Channel (PUCCH) group, a PUCCH resource group), a resource (for example, a reference signal resource, an SRS resource), a resource set (for example, a reference signal resource set), a CORESET pool, a downlink Transmission Configuration Indication state (TCI state) (DL TCI state), an uplink TCI state (UL TCI state), a unified TCI state, a common TCI state, quasi-co-location (QCL), QCL assumption, and the like may be interchangeably interpreted.

A spatial relation information Identifier (ID) (TCI state ID) and spatial relation information (TCI state) may be interchangeably interpreted. “Spatial relation information” may be used interchangeably with “a set of spatial relation information”, “one or a plurality of pieces of spatial relation information”, and the like. The TCI state and the TCI may be interchangeably interpreted.

A panel Identifier (ID) and a panel may be interchangeably interpreted. In other words, a TRP ID and a TRP, a CORESET group ID and a CORESET group, and the like may be interchangeably interpreted.

In the present disclosure, a TRP, a transmission point, a panel, a DMRS port group, a CORESET pool, and one of two TCI states associated with one codepoint of a TCI field may be interchangeably interpreted.

In the present disclosure, transmission/reception of a channel/signal using a single TRP may be used interchangeably with TCI states (joint/separate/indicated TCI states) being equal in the transmission/reception (for example, NCJT/CJT/repetition) of the channel/signal or the number of TCI states (joint/separate/indicated TCI states) being one in the transmission/reception (for example, NCJT/CJT/repetition) of the channel/signal.

Transmission/reception of a channel/signal using a single TRP may be used interchangeably with TCI states (joint/separate/indicated TCI states) being different in the transmission/reception (for example, NCJT/CJT/repetition) of the channel/signal or the number of different TCI states (joint/separate/indicated TCI states) being more than one (for example, two) in the transmission/reception (for example, NCJT/CJT/repetition) of the channel/signal.

In the present disclosure, a single TRP, a single-TRP system, single-TRP transmission, and a single PDSCH may be interchangeably interpreted. In the present disclosure, multi (multiple)-TRP, a multi-TRP system, multi-TRP transmission, and multi-PDSCH may be interchangeably interpreted.

In the present disclosure, single DCI, a single PDCCH, multi-TRP based on single DCI, two TCI states in at least one TCI codepoint being activated, at least one codepoint of a TCI field being mapped to two TCI states, a specific index (for example, a TRP index, a CORESET pool index, or an index corresponding to a TRP) being configured for a specific channel/CORESET may be interchangeably interpreted.

In the present disclosure, a single TRP, a channel/signal using a single TRP, a channel using one TCI state/spatial relation, multi-TRP being not enabled by RRC/DCI, a plurality of TCI states/spatial relations being not enabled by RRC/DCI, and one CORESET pool index (CORESETPoolIndex) value being not configured for any CORESET and any codepoint of a TCI field being not mapped to two TCI states may be interchangeably interpreted.

In the present disclosure, multi-TRP, a channel/signal using multi-TRP, a channel using a plurality of TCI states/spatial relations, multi-TRP being enabled by RRC/DCI, a plurality of TCI states/spatial relations being enabled by RRC/DCI, and at least one of multi-TRP based on single DCI and multi-TRP based on multi-DCI may be interchangeably interpreted.

In the present disclosure, multi-TRP based on multi-DCI, one CORESET pool index (CORESETPoolIndex) value being configured for a CORESET, a plurality of specific indices (for example, TRP indices, CORESET pool indices, or indices corresponding to TRPs) being configured for a specific channel/CORESET may be interchangeably interpreted.

In the present disclosure, TRP #1 (first TRP) may correspond to CORESET pool index=0 or may correspond to the first TCI state of two TCI states corresponding to one code point of a TCI field. TRP #2 (second TRP) TRP #1 (first TRP) may correspond to CORESET pool index=1 or may correspond to the second TCI state of two TCI states corresponding to one code point of a TCI field.

In the present disclosure, single DCI (sDCI), a single PDCCH, a multi-TRP system based on single DCI, sDCI-based MTRP, and two TCI states in at least one TCI codepoint being activated may be interchangeably interpreted.

In the present disclosure, multi-DCI (mDCI), multi-PDCCH, a multi-TRP system based on multi-DCI, mDCI-based MTRP, and two CORESET pool indices or CORESET pool index=1 (or a value equal to one or greater) being configured may be interchangeably interpreted.

In the present disclosure, beam indication DCI, beam indication MAC CE, and beam indication DCI/MAC CE may be interchangeably interpreted. In other words, an indication related to an indicated TCI state for a UE may be performed by using at least one of DCI and a MAC CE.

In the present disclosure, a channel, a signal, and a channel/signal may be interchangeably interpreted. In the present disclosure, a DL channel, a DL signal, a DL signal/channel, transmission/repetition of a DL signal/channel, DL reception, and DL transmission may be interchangeably interpreted. In the present disclosure, a UL channel, a UL signal, a UL signal/channel, transmission/repetition of a UL signal/channel, UL reception, and UL transmission may be interchangeably interpreted.

In the present disclosure, applying a TCI state/QCL assumption to each channel/signal/resource may mean application of a TCI state/QCL assumption to transmission and reception of each channel/signal/resource.

In the present disclosure, the first TCI state (TCI state indicated first) may correspond to the first TRP. In the present disclosure, the second TCI state (TCI state indicated second) may correspond to the second TRP. In the present disclosure, the n-th TCI state (TCI state indicated n-th) may correspond to the n-th TRP.

In the present disclosure, the first CORESET pool index value (for example, 0), the first TRP index value (for example, 1), and the first TCI state (first DL/UL (joint/separate) TCI state) may correspond to each other. In the present disclosure, the second CORESET pool index value (for example, 1), the second TRP index value (for example, 2), and the second TCI state (second DL/UL (joint/separate) TCI state) may correspond to each other.

Note that, in each embodiment of the present disclosure below, a method targeting two TRPs (i.e., a case where at least one of N and M is two) will be mainly described for application of a plurality of TCI states in transmission and reception using multiple TRPs. However, the number of TRPs may be three or more (more than one), and each embodiment may be applied so as to correspond to the number of TRPs. In other words, at least one of N and M may be a number larger than two.

In the present disclosure, a joint TCI state, a DL/UL TCI state, a separate TCI state, and a separate DL/UL TCI state may be interchangeably interpreted. An indicated joint TCI state, an indicated DL/UL TCI state, and an indicated TCI state may be interchangeably interpreted.

In the present disclosure, a plurality of TCI states configured by an RRC IE, a plurality of TCI states activated by a MAC CE, information related to one or more TCI states, a TCI state configuration, a TCI state pool, an active TCI state pool, a common TCI state pool, a unified TCI state pool, a TCI state list, a unified TCI state list, a joint TCI state pool, a separate TCI state pool, a separate DL/UL TCI state pool, a DL TCI state pool, a UL TCI state pool, a separate DL TCI state pool, and a separate UL TCI state pool may be interchangeably interpreted.

In the present disclosure, a TRP, a CORESET pool index (CORESETPoolIndex), a TRP ID, an ID related to a TRP, a TAG ID, a group of TCI states, a group of spatial relations, a group of QCL source RSS, a group of DL RSS, a group of path loss RSs, and a PCI (for an inter-cell multi-TRP) may be interchangeably interpreted.

In the present disclosure, being associated with a different TRP, being associated with a different CORESET pool index (CORESETPoolIndex), being associated with a different TRP ID, being associated with a different ID related to a TRP, being associated with a different TAG ID, being associated with a different group of TCI states, being associated with a different group spatial relations, being associated with a different group of QCL source RSs, being associated with a different group of DL RSS, being associated with a different group of path loss RSs, and being associated with a different PCI (for an inter-cell multi-TRP) may be interchangeably interpreted.

Each embodiment of the present disclosure may be applied to at least one of an intra-cell multi-TRP and an inter-cell multi-TRP.

In the present disclosure, the intra-cell multi-TRP may mean that activated TCI states of a plurality of (for example, two) TRPs are associated with the same PCI.

In the present disclosure, the inter-cell multi-TRP may mean that activated TCI states of a plurality of (for example, two) TRPs are associated with different PCIs.

In the present disclosure, in a case of the inter-cell multi-TRP, a plurality of (for example, two) TRPs may mean a plurality of (for example, two) TRPs associated with a plurality of (for example, two) PCIS.

In the present disclosure, a non-serving cell, an additional cell, a candidate cell, and a target cell may be interchangeably interpreted.

In the present disclosure, a reference cell may be used interchangeably with a specific cell. The reference cell may be a specific cell or may be a cell for which a TA value is indicated/acquired, for example. The reference cell may be defined in a specification or configured for/indicated to a UE by a base station by RRC/MAC CE/DCI.

In the present disclosure, a reference TRP may be used interchangeably with a specific TRP.

In the present disclosure, a cell switching command (L1/L2 signal (for example, DCI/MAC CE)), cell switching indication information, and information related to cell switching may be interchangeably interpreted.

The following embodiments may be applied when the RACH procedure of each TRP (or each serving cell/additional cell/non-serving cell) is configured/supported. Alternatively, the following embodiments may be applied when the timing advance/timing advance group of each TRP (or each serving cell/additional cell/non-serving cell) is configured/supported.

The following description may be applied in inter-cell mobility (for example, L1/L2 inter cell mobility) or may be applied in communication control (for example, intra-cell mobility (L1/L2 intra cell mobility)) other than inter-cell mobility.

L1/L2 inter-cell mobility may be used interchangeably with at least one of cell switching, cell switch, and cell change. In the following embodiments, a serving cell may mean only a specific cell (for example, an SpCell) or may mean both an SpCell and an SCell.

### Radio Communication Method

### First Embodiment

A first embodiment relates to configuration of a parameter(s) for each candidate cell.

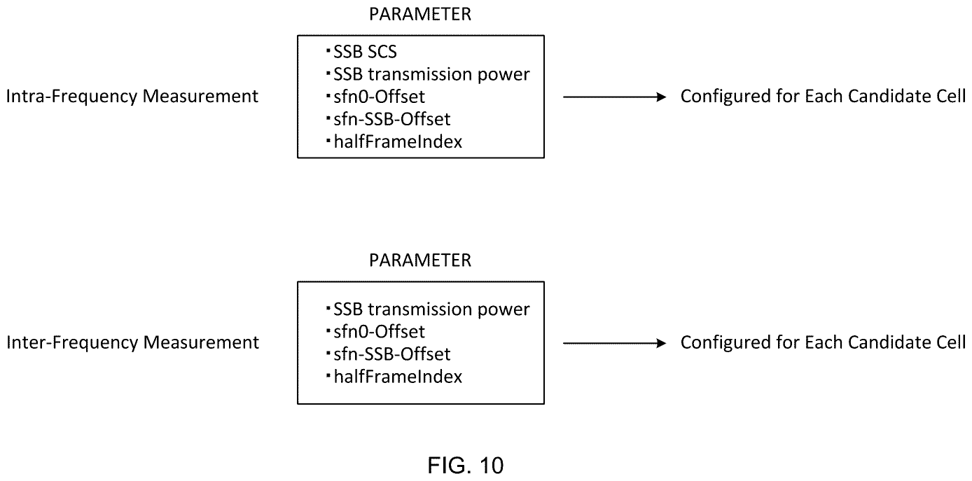

When measurement of candidate cells is supported/configured, one or a plurality of parameters for a measurement configuration of a candidate cell may be configured for each candidate cell. For example, in intra-frequency measurement (intra-F measurement)/inter-frequency measurement (inter-F measurement), one or a plurality of parameters may be configured for each candidate cell (see FIG. 10).

Measurement of a candidate cell may be measurement applied to LTM supported by Rel. 18 or later versions or may be another measurement. For example, when a given higher layer parameter is configured, a first embodiment may be applied.

### Intra-Frequency Measurement

In a case of intra-frequency measurement (intra-F measurement), at least one parameter of subcarrier spacing (SCS), transmission power, offset of system frame number 0 (sfn0-Offset), offset of system frame number (sfn-Offset), and half-frame index (halfFrameIndex) may be configured for each candidate cell.

### Inter-Frequency Measurement

In a case of inter-frequency measurement (inter-F measurement), at least one parameter of transmission power, offset of system frame number 0 (sfn0-Offset), offset of system frame number of a synchronization signal block (SSB) (sfn-SSB-Offset), and half-frame index (halfFrameIndex) may be configured for each candidate cell.

Subcarrier spacing (SCS) may be subcarrier spacing of a synchronization signal block (SSB SCS), for example.

The offset of system frame number 0 (sfn0-Offset) may indicate an offset of slot 0 of system frame number 0 of a given cell (for example, candidate cell) for slot 0 of system frame number 0 (SFN0 slot 0) of a serving cell. The offset of system frame number 0 (sfn0-Offset) may include sfn-Offset/integerSubframeOffset.

sfn-Offset may indicate an SFN offset between the cell in which an SSB is transmitted and the serving cell. The offset may correspond to the number of complete radio frames counting from the start of radio frame #0 of the serving cell to the start of closest subsequent radio frame #0 of the cell in which the SSB is transmitted. integerSubframeOffset may indicate an offset of the subframe boundary of the cell in which an SSB is transmitted.

The offset of a system frame number of a synchronization signal (SSB) (sfn-SSB-Offset) may indicate an SFN offset of a transmission SSB for the start of an SSB period. The value 0 may indicate that the SSB is transmitted in the first system frame, and the value 1 may indicate that the SSB is transmitted in the second system frame. A network may configure the field according to the field ssb-Periodicity so that an indicated system frame does not exceed configured SSB periodicity.

When no configuration is made for each parameter (for example, a given parameter) described above in a candidate cell configuration, the same parameter as that of the serving cell (for example, the same content/value as that of the parameter applied to the parameter not configured in the serving cell) may be applied to the candidate cell.

By configuring the above-described parameter(s) for each candidate cell, the candidate cell having the same frequency as a frequency of the current serving cell can have a different SCS/different SFN offset and the like. With this, it is possible to support flexible network development in LTM of Rel. 18 or later versions.

Note that a parameter(s) configurable for each candidate cell may be different between intra-frequency measurement and inter-frequency measurement as described above. Alternatively, a parameter(s) configurable for each candidate cell may be the same (in this case, those other than the frequency domain location parameter (for example, the center frequency) may be the same).

A parameter(s) indicated in intra-frequency measurement/inter-frequency measurement may be configured separately for each candidate cell or may be configured separately in units of set/combination/group of certain candidate cells. The set/combination/group of candidate cells may be configured by a higher layer parameter or may be defined in a specification in advance.

### Second Embodiment

A second embodiment relates to a case where simultaneous operations of a first operation and a second operation are supported.

In the present embodiment, a case where the first operation is inter-cell beam management (ICBM) supported in Rel. 17 and the second operation is L1/L2-triggered mobility (LTM) supported in Rel. 18 or later versions will be described. However, this is not restrictive. For example, this may be applied to a case where a first higher layer parameter is configured and a case where a second higher layer parameter is configured.

For example, the first operation may be configured/enabled/activated by the first higher layer parameter, and the second operation may be configured/enabled/activated by the second higher layer parameter. Alternatively, this may be a case of supporting configuration of a candidate cell having the same frequency as a frequency of the serving cell by the first higher layer parameter and configuration of a candidate cell having a frequency different from that of the serving cell by the second higher layer parameter.

In the following description, simultaneous configuration/simultaneous management may be based on at least one of units of BWP, units of CC, units of band, units of cell, units of cell group, and units of UE.

When simultaneous operation/simultaneous application of the first operation and the second operation is supported, interaction may be controlled based on aspect 2A/2B/2C below.

### Aspect 2A

An RRC configuration of the first operation (for example, existing Rel-17 ICBM) (for example, legacy R17 ICBM RRC configuration) may be reused, and some interactions may be considered for the RRC configuration of the first operation (for example, ICBM) and an RRC configuration of the second operation (for example, LTM).

### Option 2A-1

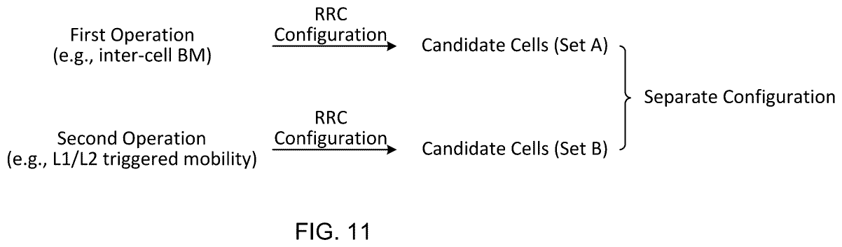

Candidate cells (for example, set A) of the first operation (for example, Rel-17 ICBM) and candidate cells (for example, set B) of the second operation (for example, Rel-18 LTM) may be configured separately (see FIG. 11). Separate configurations may each include a configuration of signaling and contents. A network may additionally indicate a relationship between the cell IDs of set B and the cell IDs of set A. The indication may be provided by configuration signaling of Rel. 18.

A UE may perform the first operation for the candidate cells of set A and perform the second operation for the candidate cells of set B.

For the cells of set B, when a cell ID related to set A is indicated, the UE may assume/determine that the two cells are the same cells. The UE may expect/assume/determine that the configurations for the cells configured by signaling of the first operation (for example, ICBM) and the second operation (for example, LTM) are the same. For the cell, both the second operation and the second operation may be performed.

For the cells of set B, only when at least one (or a combination of some/all) of the center frequency, the SSB, the SCS, the offset of system frame number 0 (sfn0-Offset), the half-frame index (halfFrameIndex), and the system frame number offset of an SSB (sfn-SSB-Offset) is the same as that of the serving cell, this may be indicated in association with the cell of set A. In other cases, this need not be indicated in association with the cell of set A.

### Option 2A-2

Candidate cells (for example, set A) of the first operation (for example, Rel-17 ICBM) and candidate cells (for example, set B) of the second operation (for example, Rel-18 LTM) may be configured separately. Separate configurations may each include signaling and contents. Cells having the same physical cell ID (PCI) may be included in both set A and set B.

A UE may perform the first operation for the candidate cells of set A and perform the second operation for the candidate cells of set B.

For the cells having the same PCI in set A and set B, the UE may assume/determine that the cells are the same cell. The UE may expect/assume/determine that the configurations for the cells configured by signaling of the first operation (for example, ICBM) and the second operation (for example, LTM) are the same.

The UE may expect/assume/determine that at least one (or a combination of some/all) of the center frequency of the cell, the SSB, the SCS, the offset of system frame number 0 (sfn0-Offset), the half-frame index (halfFrameIndex), and the system frame number offset of an SSB (sfn-SSB-Offset) is the same as that of the serving cell. Note that at least one of these parameters may be configured so as not to be present (not to be indicated) in configuration signaling. In this case, the UE may expect/assume/determine that the cell is the same as the serving cell.

As described above, by configuring candidate cells separately for the first operation and the second operation, candidate cells corresponding to each operation can be configured flexibly.

### Aspect 2B

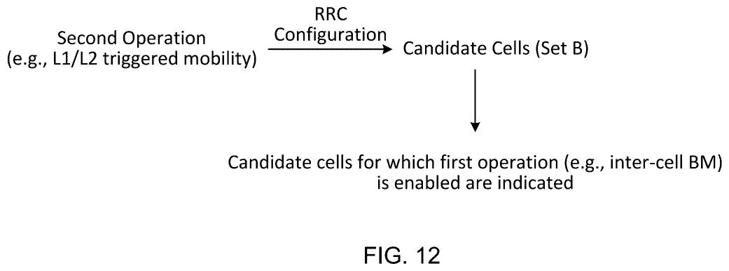

Only an RRC configuration of the second operation (for example, Rel-18 LTM) (for example, set B) may be used. Part of cells (for example, candidate cells) may further be indicated/configured via RRC to enable the function/operation of the first operation (for example, ICBM) (see FIG. 12). In the present disclosure, the function/operation of the first operation (for example, ICBM) may be used interchangeably with a function of dynamic TCI state indication without cell switching.

In this case, cells to perform the first operation may be a subset of set B of the second operation via RRC signaling.

### Option 2B-1

For the candidate cells (for example, set B) for the second operation, the network may indicate, via RRC, which cell is configured for dynamic TCI state indication of a PDSCH/PUSCH before a cell switching command.

For the cells of set B, when a cell ID related to set A is indicated, the UE may assume/determine that the two cells are the same cells. The UE may expect/assume/determine that the configurations for the cells configured by signaling of the first operation (for example, ICBM) and the second operation (for example, LTM) are the same. For the cell, both the second operation and the second operation may be performed.

For the cells of set B, only when at least one (or a combination of some/all) of the center frequency, the SSB, the SCS, the offset of system frame number 0 (sfn0-Offset), the half-frame index (halfFrameIndex), and the system frame number offset of an SSB (sfn-SSB-Offset) of a given cell is the same as that of the serving cell, indication for dynamic TCI state indication may be performed (given restriction). For a cell(s) (for example, one or more cells) indicated for dynamic TCI state indication, configuration/activation of a TCI state(s) associated with the cell(s) may be permitted before a cell switching command (for example, a MAC CE), and use of DCI for indicating the TCI state(s) associated with the cell(s) may be permitted. The UE may perform reception/transmission of a PDSCH/PUSCH by using a TCI state indicated without cell switching.

Indication of a cell(s) (for example, one or more cells) to enable dynamic TCI state indication may be indicated/updated by a MAC CE/DCI. The indicated/updated cell(s) may be controlled to satisfy the given restriction above related to at least one (or a combination of some/all) of the center frequency, the SSB, the SCS, the offset of system frame number 0 (sfn0-Offset), the half-frame index (halfFrameIndex), and the system frame number offset of an SSB (sfn-SSB-Offset).

### Option 2B-2

For the candidate cells for the second operation (for example, set B), when at least one (or a combination of some/all) of the center frequency, the SSB, the SCS, the offset of system frame number 0 (sfn0-Offset), the half-frame index (halfFrameIndex), and the system frame number offset of an SSB (sfn-SSB-Offset) of a given cell is the same as that of the serving cell, the cell may be regarded as a candidate cell to be enabled for a PDSCH/PUSCH before a cell switching command (given restriction).

Option 2B-2 may be preferably applied when a new RRC parameter is introduced and enabling/disabling of the first operation (for example, Rel-17 ICBM function) is determined.

For a cell(s) (for example, one or more cells) regarded as a candidate cell(s) of dynamic TCI state indication, configuration/activation of a TCI state(s) associated with the cell(s) may be permitted before a cell switching command (for example, a MAC CE), and use of DCI for indicating the TCI state(s) associated with the cell(s) may be permitted. The UE may perform reception/transmission of a PDSCH/PUSCH by using a TCI state indicated without cell switching.

Indication of a cell(s) (for example, one or more cells) to enable dynamic TCI state indication may further be updated by a MAC CE/DCI. The updated cell(s) may be controlled to satisfy the given restriction above related to at least one (or a combination of some/all) of the center frequency, the SSB, the SCS, the offset of system frame number 0 (sfn0-Offset), the half-frame index (halfFrameIndex), and the system frame number offset of an SSB (sfn-SSB-Offset).

### Aspect 2C

Aspect 2A and aspect 2B may be applied in combination. In addition to candidate cells configured by RRC configuration of the first operation (for example, Rel-17 ICBM), part of cells configured by RRC reconfiguration of the second operation (for example, Rel-18 LTM) may also be regarded as a candidate cell(s) of the function/operation of the first operation. In this case, the cells to perform the first operation may include the cells of set A and the part of the cells of set B.

### Option 2C-1

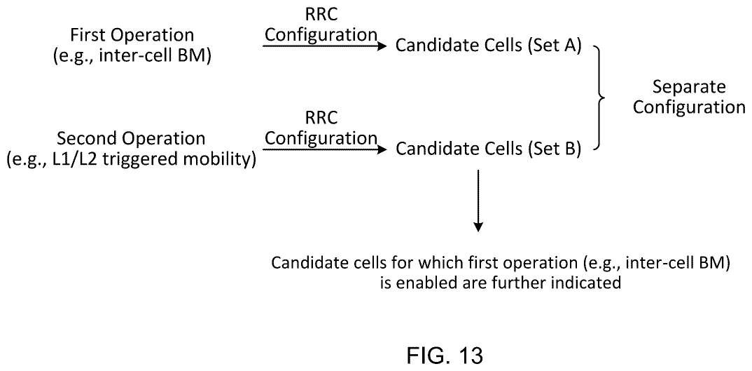

Candidate cells (for example, set A) of the first operation (for example, Rel-17 ICBM) and candidate cells (for example, set B) of the second operation (for example, Rel-18 LTM) may be configured separately. For the candidate cells of the second operation, the network may further indicate which cell is configured for dynamic TCI state indication of a PDSCH/PUSCH before a cell switching command (see FIG. 13).

For the candidate cells (for example, set B), only when at least one (or a combination of some/all) of the center frequency, the SSB, the SCS, the offset of system frame number 0 (sfn0-Offset), the half-frame index (halfFrameIndex), and the system frame number offset of an SSB (sfn-SSB-Offset) of a given cell is the same as that of the serving cell, indication for dynamic TCI state indication may be performed (given restriction).

For a cell(s) (for example, one or more cells) indicated for dynamic TCI state indication and the cells included in set A, configuration/activation of a TCI state(s) associated with the cell(s) may be permitted before a cell switching command (for example, a MAC CE), and use of DCI for indicating the TCI state(s) associated with the cell(s) may be permitted. The UE may perform reception/transmission of a PDSCH/PUSCH by using a TCI state indicated without cell switching.

### Option 2C-2

Candidate cells (for example, set A) of the first operation (for example, Rel-17 ICBM) and candidate cells (for example, set B) of the second operation (for example, Rel-18 LTM) may be configured separately. For the candidate cells of the second operation, when at least one (or a combination of some/all) of the center frequency, the SSB, the SCS, the offset of system frame number 0 (sfn0-Offset), the half-frame index (halfFrameIndex), and the system frame number offset of an SSB (sfn-SSB-Offset) of a given cell is the same as that of the serving cell, the cell may be regarded as a candidate cell to be enabled for a PDSCH/PUSCH before a cell switching command (given restriction).

Option 2C-2 may be preferably applied when a new RRC parameter is introduced and enabling/disabling of the first operation (for example, Rel-17 ICBM function) is determined.

For a cell(s) (for example, one or more cells) regarded as a candidate cell(s) of dynamic TCI state indication and the cells of set A, configuration/activation of a TCI state(s) associated with the cell(s) may be permitted before a cell switching command (for example, a MAC CE), and use of DCI for indicating the TCI state(s) associated with the cell(s) may be permitted. The UE may perform reception/transmission of a PDSCH/PUSCH by using a TCI state indicated without cell switching.

### Supplements

Notification of Information to UE

Notification of any information to a UE (from a network (NW) (for example, a base station (BS))) (in other words, reception of any information from the BS in the UE) in the above-described embodiments may be performed by using physical layer signaling (for example, DCI), higher layer signaling (for example, RRC signaling, MAC CE), a specific signal/channel (for example, a PDCCH, a PDSCH, a reference signal), or a combination of these.

When the notification is performed by a MAC CE, the MAC CE may be identified by a new logical channel ID (LCID) not defined in an existing standard being included in a MAC subheader.

When the notification is performed by DCI, the notification may be performed by a specific field of the DCI, a radio network temporary identifier (RNTI) used for scrambling of cyclic redundancy check (CRC) bits given to the DCI, a format of the DCI, or the like.

Notification of any information to a UE in the above-described embodiments may be performed periodically, semi-persistently, or aperiodically.

### Notification of Information from UE

Notification of any information from a UE (to an NW) (in other words, transmission/reporting of any information to the BS from the UE) in the above-described embodiments may be performed by using physical layer signaling (for example, UCI), higher layer signaling (for example, RRC signaling, MAC CE), a specific signal/channel (for example, a PUCCH, a PUSCH, a PRACH, a reference signal), or a combination of these.

When the notification is performed by a MAC CE, the MAC CE may be identified by a new LCID not defined in existing standards being included in a MAC subheader.

When the notification is performed by UCI, the notification may be transmitted by using a PUCCH or a PUSCH.

Notification of any information from a UE in the above-described embodiments may be performed periodically, semi-persistently, or aperiodically.

### Regarding Application of Each Embodiment

At least one of the above-described embodiments may be applied to a case satisfying a specific condition. The specific condition may be defined in a standard, or a UE/BS may be notified of the specific condition by using higher layer signaling/physical layer signaling.

At least one of the above-described embodiments may be applied only to a UE that has reported a specific UE capability or that supports the specific UE capability.

The specific UE capability may indicate at least one of the following.
supporting of specific processing/operation/control/information for at least one of the embodiments above.
supporting of intra-frequency measurement for candidate cells of LTM (for example, asynchronous candidate cells (un-sync. Candidate cells)).
supporting of intra-frequency measurement of candidate cells having at least one (or a combination of some/all) of the SSB, the SCS, the offset of system frame number 0 (sfn0-Offset), the half-frame index (halfFrameIndex), and the system frame number offset of an SSB (sfn-SSB-Offset) that different from that of the current serving cell. Note that UE capability for intra-frequency measurement for a serving cell and synchronized/asynchronous candidate cells and UE capability related to the number of asynchronous candidate cells may be provided separately.
supporting of simultaneous configuration/operation of Rel-17 ICBM configuration and Rel-18 LTM configuration.
supporting of dynamic TCI state indication associated with candidate cells, when Rel-18 LTM is configured. Note that indication of a cell(s) for which the Rel-17 ICBM function is to be enabled may be explicitly/implicitly indicated.

The specific UE capability may be capability applied over all the frequencies (commonly irrespective of frequency), capability per frequency (for example, one or a combination of cell, band, band combination, BWP, component carrier, and the like), capability per frequency range (for example, Frequency Range 1 (FR1), FR2, FR3, FR4, FR5, FR2-1, FR2-2), capability per subcarrier spacing (SCS), or capability per Feature Set (FS) or Feature Set Per Component-carrier (FSPC).

The specific UE capability may be capability applied over all the duplex schemes (commonly irrespective of duplex scheme) or capability per duplex scheme (for example, time division duplex (TDD) or frequency division duplex (FDD)).

At least one of the above-described embodiments may be applied when the UE is configured/activated/triggered with specific information related to the above-described embodiment (or performance of the operation of the above-described embodiment) by higher layer signaling/physical layer signaling. For example, the specific information may be information indicating enabling of a random access procedure/PRACH transmission without RAR monitoring, any RRC parameter for a specific release (for example, Rel. 18/19), or the like.

In a case where the UE does not support at least one of the specific UE capability or is not configured with the specific information, the UE may apply, for example, Rel-15/16 operation.

### Supplementary Notes

Regarding one embodiment of the present disclosure, the following supplementary notes of the invention will be given.

### Supplementary Note 1

A terminal including: a receiving section that receives information related to a candidate cell for which cell switching is supported by L1/L2 signaling; and a control section that controls measurement of the candidate cell, wherein one or a plurality of specific parameters are configured for at least one of intra-frequency measurement and inter-frequency measurement, for each candidate cell.

### Supplementary Note 2

The terminal according to supplementary note 1, wherein, when simultaneous operations of a first operation of configuring a candidate cell for a same frequency as a frequency of a serving cell and a second operation supporting configuration of a candidate cell for a frequency different from that of a serving cell are supported, a candidate cell corresponding to the first operation and a candidate cell corresponding to the second operation are configured separately.

### Supplementary Note 3

The terminal according to supplementary note 1 or 2, wherein, when simultaneous operations of a first operation of configuring a candidate cell for a same frequency as a frequency of a serving cell and a second operation supporting configuration of a candidate cell for a frequency different from that of a serving cell are supported, one or more candidate cells corresponding to the second operation are configured, and a candidate cell to which the first operation is to be applied is further indicated among the one or more candidate cells corresponding to the second operation.

### Supplementary Note 4

The terminal according to any one of supplementary notes 1 to 3, wherein, when simultaneous operations of a first operation of configuring a candidate cell for a same frequency as a frequency of a serving cell and a second operation supporting configuration of a candidate cell for a frequency different from that of a serving cell are supported, the first operation is applied to part of a plurality of candidate cells configured for the second operation in addition to a candidate cell corresponding to the first operation.

### Radio Communication System

Hereinafter, a structure of a radio communication system according to one embodiment of the present disclosure will be described. In this radio communication system, the radio communication method according to each embodiment of the present disclosure described above may be used alone or may be used in combination for communication.

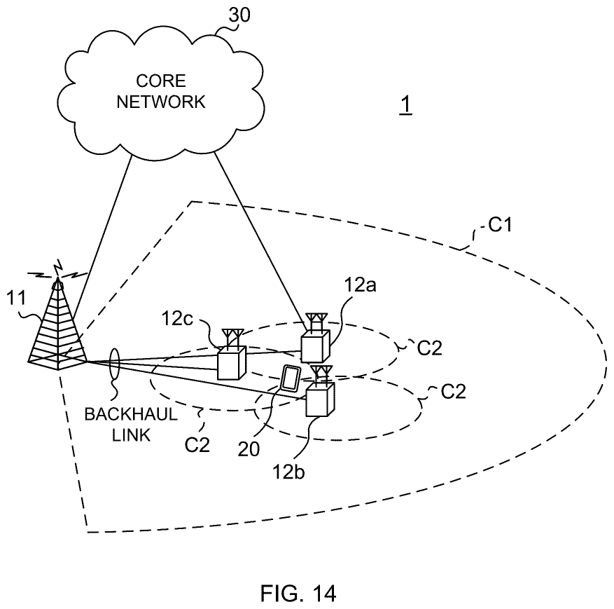

FIG. 14 is a diagram to show an example of a schematic structure of the radio communication system according to one embodiment. A radio communication system 1 (which may be simply referred to as a system 1) may be a system implementing communication using Long Term Evolution (LTE), 5th generation mobile communication system New Radio (5G NR), and so on the specifications of which have been drafted by the Third Generation Partnership Project (3GPP).

The radio communication system 1 may support dual connectivity (multi-RAT dual connectivity (MR-DC)) between a plurality of Radio Access Technologies (RATs). The MR-DC may include dual connectivity (E-UTRA-NR Dual Connectivity (EN-DC)) between LTE (Evolved Universal Terrestrial Radio Access (E-UTRA)) and NR, dual connectivity (NR-E-UTRA Dual Connectivity (NE-DC)) between NR and LTE, and so on.

In EN-DC, a base station (eNB) of LTE (E-UTRA) is a master node (MN), and a base station (gNB) of NR is a secondary node (SN). In NE-DC, a base station (gNB) of NR is an MN, and a base station (eNB) of LTE (E-UTRA) is an SN.

The radio communication system 1 may support dual connectivity between a plurality of base stations in the same RAT (for example, dual connectivity (NR-NR Dual Connectivity (NN-DC)) where both of an MN and an SN are base stations (gNB) of NR).

The radio communication system 1 may include a base station 11 that forms a macro cell C1 of a relatively wide coverage, and base stations 12 (12a to 12c) that form small cells C2, which are placed within the macro cell C1 and which are narrower than the macro cell C1. The user terminal 20 may be located in at least one cell. The arrangement, the number, and the like of each cell and user terminal 20 are by no means limited to the aspect shown in the diagram. Hereinafter, the base stations 11 and 12 will be collectively referred to as “base stations 10”, unless specified otherwise.

The user terminal 20 may be connected to at least one of the plurality of base stations 10. The user terminal 20 may use at least one of carrier aggregation (CA) and dual connectivity (DC) using a plurality of component carriers (CCs).

Each CC may be included in at least one of a first frequency band (Frequency Range 1 (FR1)) and a second frequency band (Frequency Range 2 (FR2)). The macro cell C1 may be included in FR1, and the small cells C2 may be included in FR2. For example, FRI may be a frequency band of 6 GHz or less (sub-6 GHz), and FR2 may be a frequency band which is higher than 24 GHz (above-24 GHz). Note that frequency bands, definitions and so on of FR1 and FR2 are by no means limited to these, and for example, FR1 may correspond to a frequency band which is higher than FR2.

The user terminal 20 may communicate using at least one of time division duplex (TDD) and frequency division duplex (FDD) in each CC.

The plurality of base stations 10 may be connected by a wired connection (for example, optical fiber in compliance with the Common Public Radio Interface (CPRI), the X2 interface, or the like) or a wireless connection (for example, an NR communication). For example, if an NR communication is used as a backhaul between the base stations 11 and 12, the base station 11 corresponding to a higher station may be referred to as an “Integrated Access Backhaul (IAB) donor”, and the base station 12 corresponding to a relay station (relay) may be referred to as an “IAB node.”

The base station 10 may be connected to a core network 30 through another base station 10 or directly. For example, the core network 30 may include at least one of Evolved Packet Core (EPC), 5G Core Network (5GCN), Next Generation Core (NGC), and so on.

The core network 30 may include network functions (NF), such as a User Plane Function (UPF), an Access and Mobility management Function (AMF), a Session Management Function (SMF), Unified Data Management (UDM), an Application Function (AF), a Data Network (DN), a Location Management Function (IMF), and operation, administration, and maintenance (Management) (OAM), for example. Note that a plurality of functions may be provided by one network node. Communication with an external network (for example, the Internet) may be performed via the DN.

The user terminal 20 may be a terminal supporting at least one of communication schemes such as LTE, LTE-A, 5G, and so on.

In the radio communication system 1, an orthogonal frequency division multiplexing (OFDM)-based wireless access scheme may be used. For example, in at least one of the downlink (DL) and the uplink (UL), Cyclic Prefix OFDM (CP-OFDM), Discrete Fourier Transform Spread OFDM (DFT-s-OFDM), Orthogonal Frequency Division Multiple Access (OFDMA), Single Carrier Frequency Division Multiple Access (SC-FDMA), and so on may be used.

The wireless access scheme may be referred to as a “waveform.” Note that, in the radio communication system 1, another wireless access scheme (for example, another single carrier transmission scheme, another multi-carrier transmission scheme) may be used for a wireless access scheme in the UL and the DL.

In the radio communication system 1, a downlink shared channel (Physical Downlink Shared Channel (PDSCH)), which is used by each user terminal 20 on a shared basis, a broadcast channel (Physical Broadcast Channel (PBCH)), a downlink control channel (Physical Downlink Control Channel (PDCCH)) and so on, may be used as downlink channels.

In the radio communication system 1, an uplink shared channel (Physical Uplink Shared Channel (PUSCH)), which is used by each user terminal 20 on a shared basis, an uplink control channel (Physical Uplink Control Channel (PUCCH)), a random access channel (Physical Random Access Channel (PRACH)) and so on may be used as uplink channels.

User data, higher layer control information, System Information Blocks (SIBs) and so on are communicated on the PDSCH. User data, higher layer control information and so on may be communicated on the PUSCH. The Master Information Blocks (MIBs) may be communicated on the PBCH.

Lower layer control information may be communicated on the PDCCH. For example, the lower layer control information may include downlink control information (DCI) including scheduling information of at least one of the PDSCH and the PUSCH.

Note that DCI for scheduling the PDSCH may be referred to as “DL assignment”, “DL DCI”, and so on, and DCI for scheduling the PUSCH may be referred to as “UL grant”, “UL DCI”, and so on. Note that the PDSCH may be used interchangeably with “DL data”, and the PUSCH may be used interchangeably with “UL data.”

For detection of the PDCCH, a control resource set (CORESET) and a search space may be used. The CORESET corresponds to a resource to search DCI. The search space corresponds to a search area and a search method of PDCCH candidates. One CORESET may be associated with one or more search spaces. The UE may monitor a CORESET associated with a certain search space, based on search space configuration.

One search space may correspond to a PDCCH candidate corresponding to one or more aggregation levels. One or more search spaces may be referred to as a “search space set.” Note that a “search space”, a “search space set”, a “search space configuration”, a “search space set configuration”, a “CORESET”, a “CORESET configuration” and so on of the present disclosure may be interchangeably interpreted.

Uplink control information (UCI) including at least one of channel state information (CSI), transmission confirmation information (for example, which may be referred to as Hybrid Automatic Repeat reQuest ACKnowledgement (HARQ-ACK), ACK/NACK, and so on), and scheduling request (SR) may be communicated by means of the PUCCH. By means of the PRACH, random access preambles for establishing connections with cells may be communicated.

Note that the downlink, the uplink, and so on in the present disclosure may be expressed without a term of “link.” In addition, various channels may be expressed without adding “Physical” to the head.

In the radio communication system 1, a synchronization signal (SS), a downlink reference signal (DL-RS), and so on may be communicated. In the radio communication system 1, a cell-specific reference signal (CRS), a channel state information-reference signal (CSI-RS), a demodulation reference signal (DMRS), a positioning reference signal (PRS), a phase tracking reference signal (PTRS), and so on may be communicated as the DL-RS.

For example, the synchronization signal may be at least one of a primary synchronization signal (PSS) and a secondary synchronization signal (SSS). A signal block including an SS (PSS, SSS) and a PBCH (and a DMRS for a PBCH) may be referred to as an “SS/PBCH block”, an “SS Block (SSB)”, and so on. Note that an SS, an SSB, and so on may be referred to as a “reference signal.”

In the radio communication system 1, a sounding reference signal (SRS), a demodulation reference signal (DMRS), and so on may be communicated as an uplink reference signal (UL-RS). Note that DMRS may be referred to as a “user terminal specific reference signal (UE-specific Reference Signal).”

### Base Station

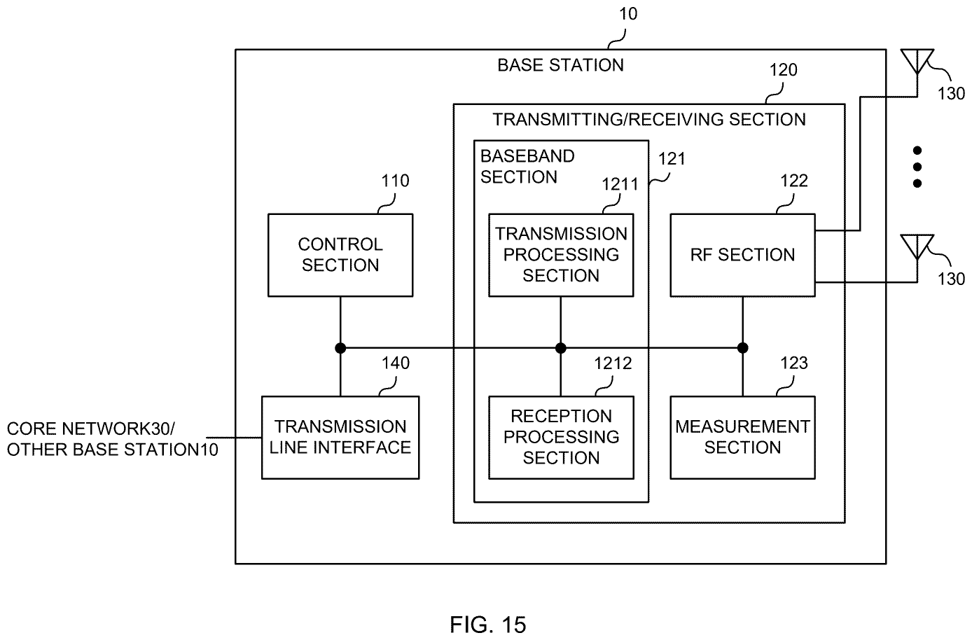

FIG. 15 is a diagram to show an example of a structure of the base station according to one embodiment. The base station 10 includes a control section 110, a transmitting/receiving section 120, transmitting/receiving antennas 130 and a transmission line interface 140. Note that the base station 10 may include one or more control sections 110, one or more transmitting/receiving sections 120, one or more transmitting/receiving antennas 130, and one or more transmission line interfaces 140.

Note that, the present example primarily shows functional blocks that pertain to characteristic parts of the present embodiment, and it is assumed that the base station 10 may include other functional blocks that are necessary for radio communication as well. Part of the processes of each section described below may be omitted.

The control section 110 controls the whole of the base station 10. The control section 110 can be constituted with a controller, a control circuit, or the like described based on general understanding of the technical field to which the present disclosure pertains.

The control section 110 may control generation of signals, scheduling (for example, resource allocation, mapping), and so on. The control section 110 may control transmission and reception, measurement and so on using the transmitting/receiving section 120, the transmitting/receiving antennas 130, and the transmission line interface 140. The control section 110 may generate data, control information, a sequence and so on to transmit as a signal, and forward the generated items to the transmitting/receiving section 120. The control section 110 may perform call processing (setting up, releasing) for communication channels, manage the state of the base station 10, and manage the radio resources.

The transmitting/receiving section 120 may include a baseband section 121, a Radio Frequency (RF) section 122, and a measurement section 123. The baseband section 121 may include a transmission processing section 1211 and a reception processing section 1212. The transmitting/receiving section 120 can be constituted with a transmitter/receiver, an RF circuit, a baseband circuit, a filter, a phase shifter, a measurement circuit, a transmitting/receiving circuit, or the like described based on general understanding of the technical field to which the present disclosure pertains.

The transmitting/receiving section 120 may be structured as a transmitting/receiving section in one entity, or may be constituted with a transmitting section and a receiving section. The transmitting section may be constituted with the transmission processing section 1211, and the RF section 122. The receiving section may be constituted with the reception processing section 1212, the RF section 122, and the measurement section 123.

The transmitting/receiving antennas 130 can be constituted with antennas, for example, an array antenna, or the like described based on general understanding of the technical field to which the present disclosure pertains.

The transmitting/receiving section 120 may transmit the above-described downlink channel, synchronization signal, downlink reference signal, and so on. The transmitting/receiving section 120 may receive the above-described uplink channel, uplink reference signal, and so on.

The transmitting/receiving section 120 may form at least one of a transmit beam and a receive beam by using digital beam forming (for example, precoding), analog beam forming (for example, phase rotation), and so on.

The transmitting/receiving section 120 (transmission processing section 1211) may perform the processing of the Packet Data Convergence Protocol (PDCP) layer, the processing of the Radio Link Control (RLC) layer (for example, RLC retransmission control), the processing of the Medium Access Control (MAC) layer (for example, HARQ retransmission control), and so on, for example, on data and control information and so on acquired from the control section 110, and may generate bit string to transmit.

The transmitting/receiving section 120 (transmission processing section 1211) may perform transmission processing such as channel coding (which may include error correction coding), modulation, mapping, filtering, discrete Fourier transform (DFT) processing (as necessary), inverse fast Fourier transform (IFFT) processing, precoding, digital-to-analog conversion, and so on, on the bit string to transmit, and output a baseband signal.

The transmitting/receiving section 120 (RF section 122) may perform modulation to a radio frequency band, filtering, amplification, and so on, on the baseband signal, and transmit the signal of the radio frequency band through the transmitting/receiving antennas 130.

On the other hand, the transmitting/receiving section 120 (RF section 122) may perform amplification, filtering, demodulation to a baseband signal, and so on, on the signal of the radio frequency band received by the transmitting/receiving antennas 130.

The transmitting/receiving section 120 (reception processing section 1212) may apply reception processing such as analog-digital conversion, fast Fourier transform (FFT) processing, inverse discrete Fourier transform (IDFT) processing (as necessary), filtering, de-mapping, demodulation, decoding (which may include error correction decoding), MAC layer processing, the processing of the RLC layer and the processing of the PDCP layer, and so on, on the acquired baseband signal, and acquire user data, and so on.

The transmitting/receiving section 120 (measurement section 123) may perform the measurement related to the received signal. For example, the measurement section 123 may perform Radio Resource Management (RRM) measurement, Channel State Information (CSI) measurement, and so on, based on the received signal. The measurement section 123 may measure a received power (for example, Reference Signal Received Power (RSRP)), a received quality (for example, Reference Signal Received Quality (RSRQ), a Signal to Interference plus Noise Ratio (SINR), a Signal to Noise Ratio (SNR)), a signal strength (for example, Received Signal Strength Indicator (RSSI)), channel information (for example, CSI), and so on. The measurement results may be output to the control section 110.

The transmission line interface 140 may perform transmission/reception (backhaul signaling) of a signal with an apparatus included in the core network 30 (for example, a network node providing NF) or another base station 10, and so on, and acquire or transmit user data (user plane data), control plane data, and so on for the user terminal 20, for example.

Note that the transmitting section and the receiving section of the base station 10 in the present disclosure may be constituted with at least one of the transmitting/receiving section 120, the transmitting/receiving antennas 130, and the transmission line interface 140.

The transmitting/receiving section 120 may transmit, to a terminal, information related to a candidate cell for which cell switching is supported by L1/L2 signaling.

The control section 110 may indicate measurement of the candidate cell in the terminal. The control section 110 may configure one or a plurality of specific parameters for at least one of intra-frequency measurement and inter-frequency measurement, for each candidate cell.

### User Terminal

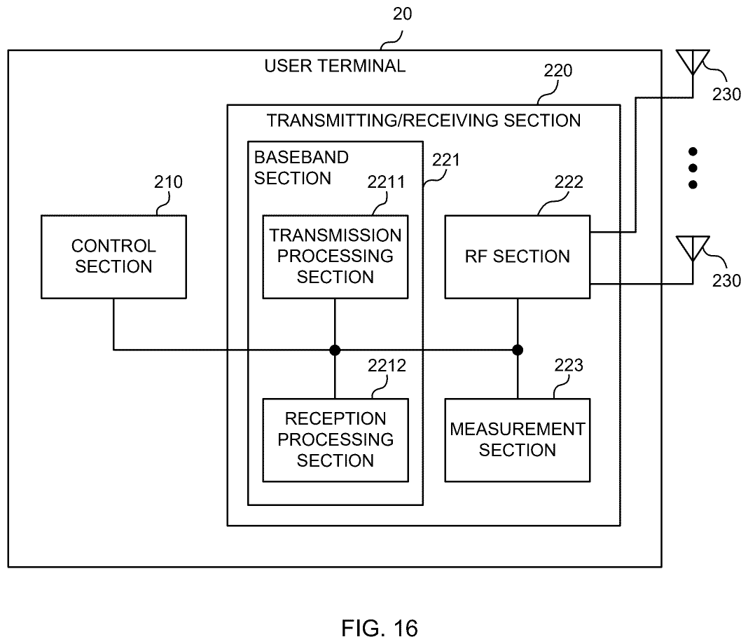

FIG. 16 is a diagram to show an example of a structure of the user terminal according to one embodiment. The user terminal 20 includes a control section 210, a transmitting/receiving section 220, and transmitting/receiving antennas 230. Note that the user terminal 20 may include one or more control sections 210, one or more transmitting/receiving sections 220, and one or more transmitting/receiving antennas 230.

Note that, the present example primarily shows functional blocks that pertain to characteristic parts of the present embodiment, and it is assumed that the user terminal 20 may include other functional blocks that are necessary for radio communication as well. Part of the processes of each section described below may be omitted.

The control section 210 controls the whole of the user terminal 20. The control section 210 can be constituted with a controller, a control circuit, or the like described based on general understanding of the technical field to which the present disclosure pertains.

The control section 210 may control generation of signals, mapping, and so on. The control section 210 may control transmission/reception, measurement and so on using the transmitting/receiving section 220, and the transmitting/receiving antennas 230. The control section 210 generates data, control information, a sequence and so on to transmit as a signal, and may forward the generated items to the transmitting/receiving section 220.

The transmitting/receiving section 220 may include a baseband section 221, an RF section 222, and a measurement section 223. The baseband section 221 may include a transmission processing section 2211 and a reception processing section 2212. The transmitting/receiving section 220 can be constituted with a transmitter/receiver, an RF circuit, a baseband circuit, a filter, a phase shifter, a measurement circuit, a transmitting/receiving circuit, or the like described based on general understanding of the technical field to which the present disclosure pertains.

The transmitting/receiving section 220 may be structured as a transmitting/receiving section in one entity, or may be constituted with a transmitting section and a receiving section. The transmitting section may be constituted with the transmission processing section 2211, and the RF section 222. The receiving section may be constituted with the reception processing section 2212, the RF section 222, and the measurement section 223.

The transmitting/receiving antennas 230 can be constituted with antennas, for example, an array antenna, or the like described based on general understanding of the technical field to which the present disclosure pertains.

The transmitting/receiving section 220 may receive the above-described downlink channel, synchronization signal, downlink reference signal, and so on. The transmitting/receiving section 220 may transmit the above-described uplink channel, uplink reference signal, and so on.

The transmitting/receiving section 220 may form at least one of a transmit beam and a receive beam by using digital beam forming (for example, precoding), analog beam forming (for example, phase rotation), and so on.

The transmitting/receiving section 220 (transmission processing section 2211) may perform the processing of the PDCP layer, the processing of the RLC layer (for example, RLC retransmission control), the processing of the MAC layer (for example, HARQ retransmission control), and so on, for example, on data and control information and so on acquired from the control section 210, and may generate bit string to transmit.

The transmitting/receiving section 220 (transmission processing section 2211) may perform transmission processing such as channel coding (which may include error correction coding), modulation, mapping, filtering, DFT processing (as necessary), IFFT processing, precoding, digital-to-analog conversion, and so on, on the bit string to transmit, and output a baseband signal.

Note that, whether to apply DFT processing or not may be based on the configuration of the transform precoding. The transmitting/receiving section 220 (transmission processing section 2211) may perform, for a certain channel (for example, PUSCH), the DFT processing as the above-described transmission processing to transmit the channel by using a DFT-s-OFDM waveform if transform precoding is enabled, and otherwise, does not need to perform the DFT processing as the above-described transmission processing.

The transmitting/receiving section 220 (RF section 222) may perform modulation to a radio frequency band, filtering, amplification, and so on, on the baseband signal, and transmit the signal of the radio frequency band through the transmitting/receiving antennas 230.

On the other hand, the transmitting/receiving section 220 (RF section 222) may perform amplification, filtering, demodulation to a baseband signal, and so on, on the signal of the radio frequency band received by the transmitting/receiving antennas 230.

The transmitting/receiving section 220 (reception processing section 2212) may apply reception processing such as analog-digital conversion, FFT processing, IDFT processing (as necessary), filtering, de-mapping, demodulation, decoding (which may include error correction decoding), MAC layer processing, the processing of the RLC layer and the processing of the PDCP layer, and so on, on the acquired baseband signal, and acquire user data, and so on.

The transmitting/receiving section 220 (measurement section 223) may perform the measurement related to the received signal. For example, the measurement section 223 may perform RRM measurement, CSI measurement, and so on, based on the received signal. The measurement section 223 may measure a received power (for example, RSRP), a received quality (for example, RSRQ, SINR, SNR), a signal strength (for example, RSSI), channel information (for example, CSI), and so on. The measurement results may be output to the control section 210.

Note that the measurement section 223 may derive channel measurement for CSI computation, based on a resource for channel measurement. The resource for channel measurement may be a non zero power (NZP) CSI-RS resource, for example. The measurement section 223 may derive interference measurement for CSI computation, based on a resource for interference measurement. The resource for interference measurement may be at least one of an NZP CSI-RS resource for interference measurement, a CSI-interference measurement (IM) resource, and the like. Note that the CSI-IM may be referred to as CSI-interference management (IM), and CSI-IM and zero power (ZP) CSI-RS may be interchangeably interpreted. Note that, in the present disclosure, a CSI-RS, an NZP CSI-RS, a ZP CSI-RS, a CSI-IM, a CSI-SSB, and the like may be interchangeably interpreted.

Note that the transmitting section and the receiving section of the user terminal 20 in the present disclosure may be constituted with at least one of the transmitting/receiving section 220 and the transmitting/receiving antennas 230.

The transmitting/receiving section 220 may receive information related to a candidate cell for which cell switching is supported by L1/L2 signaling.

The control section 210 may control measurement of the candidate cell. One or a plurality of specific parameters may be configured for at least one of intra-frequency measurement and inter-frequency measurement, for each candidate cell.

When simultaneous operations of a first operation of configuring a candidate cell for a same frequency as a frequency of a serving cell and a second operation supporting configuration of a candidate cell for a frequency different from that of a serving cell are supported, a candidate cell corresponding to the first operation and a candidate cell corresponding to the second operation may be configured separately.

When simultaneous operations of a first operation of configuring a candidate cell for a same frequency as a frequency of a serving cell and a second operation supporting configuration of a candidate cell for a frequency different from that of a serving cell are supported, one or more candidate cells corresponding to the second operation may be configured, and a candidate cell to which the first operation is to be applied may be further indicated among the one or more candidate cells corresponding to the second operation.

When simultaneous operations of a first operation of configuring a candidate cell for a same frequency as a frequency of a serving cell and a second operation supporting configuration of a candidate cell for a frequency different from that of a serving cell are supported, the first operation may be applied to part of a plurality of candidate cells configured for the second operation in addition to a candidate cell corresponding to the first operation.

### Hardware Structure

Note that the block diagrams that have been used to describe the above embodiments show blocks in functional units. These functional blocks (components) may be implemented in arbitrary combinations of at least one of hardware and software. Also, the method for implementing each functional block is not particularly limited. That is, each functional block may be realized by one piece of apparatus that is physically or logically coupled, or may be realized by directly or indirectly connecting two or more physically or logically separate apparatuses (for example, via wire, wireless, or the like) and using these apparatuses. The functional blocks may be implemented by combining software into the apparatus described above or the plurality of apparatuses described above.

Here, functions include judgment, determination, decision, calculation, computation, processing, derivation, investigation, search, confirmation, reception, transmission, output, access, resolution, selection, designation, establishment, comparison, assumption, expectation, considering, broadcasting, notifying, communicating, forwarding, configuring, reconfiguring, allocating (mapping), assigning, and the like, but functions are by no means limited to these. For example, a functional block (component) to implement a function of transmission may be referred to as a “transmitting section (transmitting unit)”, a “transmitter”, or the like. The method for implementing each component is not particularly limited as described above.

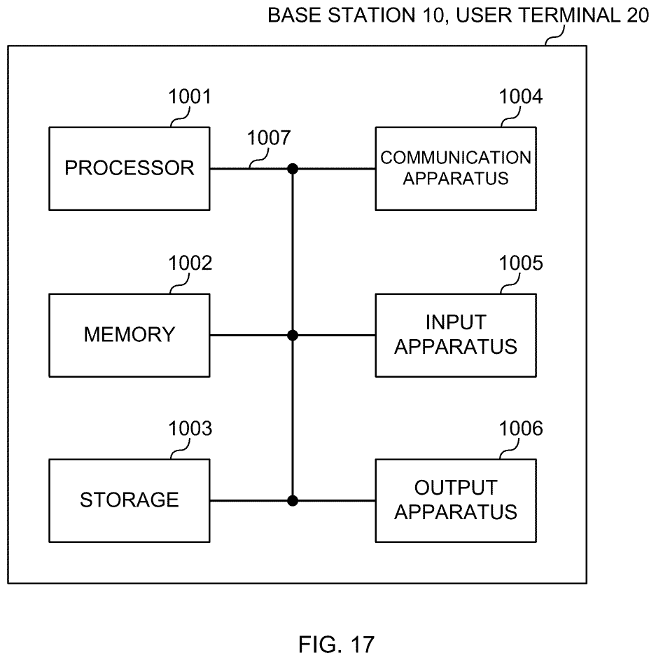

For example, a base station, a user terminal, and so on according to one embodiment of the present disclosure may function as a computer that executes the processes of the radio communication method of the present disclosure. FIG. 17 is a diagram to show an example of a hardware structure of the base station and the user terminal according to one embodiment.

Physically, the above-described base station 10 and user terminal 20 may each be formed as a computer apparatus that includes a processor 1001, a memory 1002, a storage 1003, a communication apparatus 1004, an input apparatus 1005, an output apparatus 1006, a bus 1007, and so on.

Note that in the present disclosure, the words such as an apparatus, a circuit, a device, a section, a unit, and so on can be interchangeably used. The hardware structure of the base station 10 and the user terminal 20 may be configured to include one or more of apparatuses shown in the drawings, or may be configured not to include part of apparatuses.

For example, although one processor 1001 is shown in the drawings, a plurality of processors may be provided. Furthermore, processes may be implemented with one processor or may be implemented at the same time, in sequence, or in different manners with two or more processors. Note that the processor 1001 may be implemented with one or more chips.

Each function of the base station 10 and the user terminal 20 is implemented, for example, by allowing given software (programs) to be read on hardware such as the processor 1001 and the memory 1002, and by allowing the processor 1001 to perform calculations to control communication via the communication apparatus 1004 and control at least one of reading and writing of data in the memory 1002 and the storage 1003.

The processor 1001 controls the whole computer by, for example, running an operating system. The processor 1001 may be configured with a central processing unit (CPU), which includes interfaces with peripheral apparatus, control apparatus, computing apparatus, a register, and so on. For example, at least a part of the control section 110 (210), the transmitting/receiving section 120 (220), and so on may be implemented by the processor 1001.

Furthermore, the processor 1001 reads programs (program codes), software modules, data, and so on from at least one of the storage 1003 and the communication apparatus 1004, into the memory 1002, and executes various processes according to these. As for the programs, programs to allow computers to execute at least a part of the operations explained in the above-described embodiments are used. For example, the control section 110 (210) may be implemented by control programs that are stored in the memory 1002 and that operate on the processor 1001, and other functional blocks may be implemented likewise.

The memory 1002 is a computer-readable recording medium, and may be constituted with, for example, at least one of a Read Only Memory (ROM), an Erasable Programmable ROM (EPROM), an Electrically EPROM (EEPROM), a Random Access Memory (RAM), and other appropriate storage media. The memory 1002 may be referred to as a “register”, a “cache”, a “main memory (primary storage apparatus)” and so on. The memory 1002 can store executable programs (program codes), software modules, and the like for implementing the radio communication method according to one embodiment of the present disclosure.

The storage 1003 is a computer-readable recording medium, and may be constituted with, for example, at least one of a flexible disk, a floppy (registered trademark) disk, a magneto-optical disk (for example, a compact disc (Compact Disc ROM (CD-ROM) and so on), a digital versatile disc, a Blu-ray (registered trademark) disk), a removable disk, a hard disk drive, a smart card, a flash memory device (for example, a card, a stick, and a key drive), a magnetic stripe, a database, a server, and other appropriate storage media. The storage 1003 may be referred to as “auxiliary storage apparatus”.

The communication apparatus 1004 is hardware (transmitting/receiving device) for allowing inter-computer communication via at least one of wired and wireless networks, and may be referred to as, for example, a “network device”, a “network controller”, a “network card”, a “communication module”, and so on. The communication apparatus 1004 may be configured to include a high frequency switch, a duplexer, a filter, a frequency synthesizer, and so on in order to realize, for example, at least one of frequency division duplex (FDD) and time division duplex (TDD). For example, the transmitting/receiving section 120 (220), the transmitting/receiving antenna 130 (230), and so on may be implemented by the communication apparatus 1004. In the transmitting/receiving section 120 (220), the transmitting section 120a (220a) and the receiving section 120b (220b) can be implemented while being separated physically or logically.

The input apparatus 1005 is an input device that receives input from the outside (for example, a keyboard, a mouse, a microphone, a switch, a button, a sensor or the like). The output apparatus 1006 is an output device that allows sending output to the outside (for example, a display, a speaker, a Light Emitting Diode (LED) lamp or the like). Note that the input apparatus 1005 and the output apparatus 1006 may be provided in an integrated structure (for example, a touch panel).

Furthermore, these types of apparatus, including the processor 1001, the memory 1002, and others, are connected by a bus 1007 for communicating information. The bus 1007 may be formed with a single bus, or may be formed with buses that vary between apparatuses.

Also, the base station 10 and the user terminal 20 may be structured to include hardware such as a microprocessor, a Digital Signal Processor (DSP), an Application Specific Integrated Circuit (ASIC), a Programmable Logic Device (PLD), a Field Programmable Gate Array (FPGA), and so on, and a part or all of the functional blocks may be implemented by the hardware. For example, the processor 1001 may be implemented with at least one of these pieces of hardware.

### Variations

It should be noted that a term used in the present disclosure and a term required for understanding of the present disclosure may be replaced by a term having the same or similar meaning. For example, a channel, a symbol, and a signal (or signaling) may be interchangeably used. Further, a signal may be a message. A reference signal may be abbreviated as an RS, and may be referred to as a pilot, a pilot signal or the like, depending on which standard applies. Furthermore, a component carrier (CC) may be referred to as a cell, a frequency carrier, a carrier frequency and so on.

A radio frame may be constituted of one or a plurality of periods (frames) in the time domain. Each of one or a plurality of periods (frames) constituting a radio frame may be referred to as a “subframe”. Furthermore, a subframe may be constituted of one or a plurality of slots in the time domain. A subframe may be a fixed time length (for example, 1 ms) independent of numerology.

Here, numerology may be a communication parameter applied to at least one of transmission and reception of a given signal or channel. For example, numerology may indicate at least one of a subcarrier spacing (SCS), a bandwidth, a symbol length, a cyclic prefix length, a transmission time interval (TTI), the number of symbols per TTI, a radio frame structure, a specific filter processing performed by a transceiver in the frequency domain, a specific windowing processing performed by a transceiver in the time domain, and so on.

A slot may be constituted of one or a plurality of symbols in the time domain (Orthogonal Frequency Division Multiplexing (OFDM) symbols, Single Carrier Frequency Division Multiple Access (SC-FDMA) symbols, and so on). Furthermore, a slot may be a time unit based on numerology.

A slot may include a plurality of mini-slots. Each mini-slot may be constituted of one or a plurality of symbols in the time domain. A mini-slot may be referred to as a “sub-slot”. A mini-slot may be constituted of symbols in number less than the slot. A PDSCH (or PUSCH) transmitted in a time unit larger than a mini-slot may be referred to as “PDSCH (PUSCH) mapping type A”. A PDSCH (or PUSCH) transmitted using a mini-slot may be referred to as “PDSCH (PUSCH) mapping type B”.

A radio frame, a subframe, a slot, a mini-slot, and a symbol all express time units in signal communication. A radio frame, a subframe, a slot, a mini-slot, and a symbol may each be called by other applicable terms. Note that time units such as a frame, a subframe, a slot, mini-slot, and a symbol in the present disclosure may be interchangeably used.

For example, one subframe may be referred to as a “TTI”, a plurality of consecutive subframes may be referred to as a “TTI”, or one slot or one mini-slot may be referred to as a “TTI”. In other words, at least one of a subframe and a TTI may be a subframe (1 ms) in existing LTE, may be a period shorter than 1 ms (for example, 1 to 13 symbols), or may be a period longer than 1 ms. Note that a unit expressing TTI may be referred to as a “slot”, a “mini-slot”, or the like, instead of a “subframe”.

Here, a TTI refers to the minimum time unit of scheduling in radio communication, for example. For example, in LTE systems, a base station performs, for user terminals, scheduling of allocating of radio resources (such as a frequency bandwidth and transmit power that are available for each user terminal) in TTI units. Note that the definition of THIS is not limited to this.

The TTI may be a transmission time unit for channel-encoded data packets (transport blocks), code blocks, codewords, or the like, or may be a unit of processing in scheduling, link adaptation, or the like. Note that, when a TTI is given, a time interval (for example, the number of symbols) to which transport blocks, code blocks, codewords, or the like are actually mapped may be shorter than the TTI.

Note that, in the case where one slot or one mini-slot is referred to as a TTI, one or more TTIs (that is, one or more slots or one or more mini-slots) may be the minimum time unit of scheduling. Furthermore, the number of slots (the number of mini-slots) constituting the minimum time unit of the scheduling may be controlled.

A TTI having a time length of 1 ms may be referred to as a “normal TTI” (TTI in 3GPP Rel. 8 to Rel. 12), a “long TTI”, a “normal subframe”, a “long subframe”, a “slot” and so on. A TTI that is shorter than a normal TTI may be referred to as a “shortened TTI”, a “short TTI”, a “partial or fractional TTI”, a “shortened subframe”, a “short subframe”, a “mini-slot”, a “sub-slot”, a “slot” and so on.

Note that a long TTI (for example, a normal TTI, a subframe, and so on) may be used interchangeably with a TTI having a time length exceeding 1 ms, and a short TTI (for example, a shortened TTI and so on) may be used interchangeably with a TTI having a TTI length shorter than the TTI length of a long TTI and equal to or longer than 1 ms.

A resource block (RB) is the unit of resource allocation in the time domain and the frequency domain, and may include one or a plurality of consecutive subcarriers in the frequency domain. The number of subcarriers included in an RB may be the same regardless of numerology, and, for example, may be 12. The number of subcarriers included in an RB may be determined based on numerology.

Also, an RB may include one or a plurality of symbols in the time domain, and may be one slot, one mini-slot, one subframe, or one TTI in length. One TTI, one subframe, and so on each may be constituted of one or a plurality of resource blocks.

Note that one or a plurality of RBs may be referred to as a “physical resource block (Physical RB (PRB))”, a “sub-carrier group (SCG)”, a “resource element group (REG)”, a “PRB pair”, an “RB pair” and so on.

Furthermore, a resource block may be constituted of one or a plurality of resource elements (REs). For example, one RE may correspond to a radio resource field of one subcarrier and one symbol.

A bandwidth part (BWP) (which may be referred to as a “fractional bandwidth”, and so on) may represent a subset of contiguous common resource blocks (common RBs) for certain numerology in a certain carrier. Here, a common RB may be specified by an index of the RB based on the common reference point of the carrier. A PRB may be defined by a certain BWP and may be numbered in the BWP.

The BWP may include a UL BWP (BWP for UL) and a DL BWP (BWP for DL). One or a plurality of BWPs may be configured in one carrier for a UE.

At least one of configured BWPs may be active, and a UE may not need to assume to transmit/receive a given signal/channel outside the active BWP(s). Note that a “cell”, a “carrier”, and so on in the present disclosure may be used interchangeably with a “BWP”.

Note that the above-described structures of radio frames, subframes, slots, mini-slots, symbols, and so on are merely examples. For example, structures such as the number of subframes included in a radio frame, the number of slots per subframe or radio frame, the number of mini-slots included in a slot, the numbers of symbols and RBs included in a slot or a mini-slot, the number of subcarriers included in an RB, the number of symbols in a TTI, the symbol length, the cyclic prefix (CP) length, and so on can be variously changed.

Further, the information, parameters, and so on described in the present disclosure may be expressed using absolute values or relative values with respect to given values, or may be expressed using another corresponding information. For example, a radio resource may be specified by a given index.

The names used for parameters and so on in the present disclosure are in no respect used as limitations. Furthermore, mathematical expressions that use these parameters, and so on may be different from those explicitly disclosed in the present disclosure. Since various channels (PUCCH, PDCCH, and so on) and information elements may be identified by any suitable names, the various names allocated to these various channels and information elements are in no respect used as limitations.

The information, signals, and so on described in the present disclosure may be represented by using any of a variety of different technologies. For example, data, an instruction, a command, information, a signal, a bit, a symbol, a chip, and so on, described throughout the description of the present application, may be represented by a voltage, an electric current, electromagnetic waves, magnetic fields, a magnetic particle, optical fields, a photon, or any combination thereof.

Also, information, signals, and so on can be output at least one of from a higher layer to a lower layer and from a lower layer to a higher layer. Information, signals, and so on may be input and/or output via a plurality of network nodes.

The information, signals, and so on that are input and/or output may be stored in a specific location (for example, a memory) or may be managed by using a management table. The information, signals, and so on to be input and/or output can be overwritten, updated, or added. The information, signals, and so on that has been output may be deleted. The information, signals, and so on that has been input may be transmitted to another apparatus.

Notification of information is by no means limited to the aspects/embodiments described in the present disclosure, and other methods may be used as well. For example, notification of information in the present disclosure may be implemented by using physical layer signaling (for example, downlink control information (DCI), uplink control information (UCI)), higher layer signaling (for example, Radio Resource Control (RRC) signaling, broadcast information (master information block (MIB), system information block (SIB), and so on), Medium Access Control (MAC) signaling and so on), and other signals or combinations of these.

Note that physical layer signaling may be referred to as “Layer 1/Layer 2 (L1/L2) control information (L1/L2 control signals)”, “L1 control information (L1 control signal)”, and so on. Also, RRC signaling may be referred to as an “RRC message”, and can be, for example, an RRC connection setup message, an RRC connection reconfiguration message, and so on. Also, MAC signaling may be notified using, for example, MAC control elements (MAC CES).

Also, notification of given information (for example, notification of “X”) does not necessarily have to be performed explicitly, and can be performed implicitly (by, for example, not reporting this given information or reporting another piece of information).

A decision may be realized by a value (0 or 1) represented by one bit, by a boolean value (true or false), or by comparison of numerical values (e.g., comparison with a given value).

Software, irrespective of whether referred to as “software”, “firmware”, “middleware”, “microcode”, or “hardware description language”, or called by other terms, should be interpreted broadly to mean instructions, instruction sets, codes, code segments, program codes, programs, subprograms, software modules, applications, software applications, software packages, routines, subroutines, objects, executable files, execution threads, procedures, functions, and the like.

Also, software, instructions, information, and the like may be transmitted and received via a transmission medium. For example, when software is transmitted from a website, a server, or other remote sources by using at least one of wired technologies (coaxial cable, fiber optic cable, twisted-pair cable, digital subscriber line (DSL), and so on) and wireless technologies (infrared radiation, microwaves, and so on), at least one of these wired technologies and wireless technologies is also included in the definition of the transmission medium.

The terms “system” and “network” used in the present disclosure may be used interchangeably. The “network” may mean an apparatus (for example, a base station) included in the network.

In the present disclosure, the terms such as “precoding”, a “precoder”, a “weight (precoding weight)”, “quasi-co-location (QCL)”, a “Transmission Configuration Indication state (TCI state)”, a “spatial relation”, a “spatial domain filter”, a “transmit power”, “phase rotation”, an “antenna port”, a “layer”, “the number of layers”, a “rank”, a “resource”, a “resource set”, a “beam”, a “beam width”, a “beam angular degree”, an “antenna”, an “antenna element”, a “panel”, a “UE panel”, a “transmission entity”, a “reception entity”, and so on may be used interchangeably.

Note that, in the present disclosure, the “antenna port” may be used interchangeably with an “antenna port for an arbitrary signal/channel” (for example, a demodulation reference signal (DMRS) port). In the present disclosure, the “resource” may be used interchangeably with a “resource for an arbitrary signal/channel” (e.g., a reference signal resource, an SRS resource, and the like). The resource may include time/frequency/code/space/power resource. The spatial domain transmission filter may include at least one of a spatial domain transmission filter and a spatial domain reception filter.

The group may include at least one of, for example, a spatial relationship group, a code division multiplexing (CDM) group, a reference signal (RS) group, a control resource set (CORESET) group, a PUCCH group, an antenna port group (for example, a DMRS port group), a layer group, a resource group, a beam group, an antenna group, a panel group, and the like.

In the present disclosure, a “beam”, an “SRS resource indicator (SRI)”, a “CORESET”, a “CORESET pool”, a “PDSCH”, a “PUSCH”, a “codeword (CW)”, a “transport block (TB)”, an “RS”, and the like may be interchangeably used.

In the present disclosure, a “TCI state”, a “downlink TCI state (DL TCI state)”, an “uplink TCI state (UL TCI state)”, a “unified TCI state”, a “common TCI state”, a “joint TCI state”, and the like may be used interchangeably.

In the present disclosure, “QCL”, “QCL assumption”, “QCL relationship”, “QCL type information”, “QCL property/properties”, “specific QCL type (e.g., type A, type D) property”, “specific QCL type (e.g., type A, type D)”, and the like may be used interchangeably.

In the present disclosure, an “index”, an “identifier (ID)”, an “indicator”, “indication”, a “resource ID”, and the like may be used interchangeably. In the present disclosure, a sequence, a list, a set, a group, a cluster, a subset, and the like may be used interchangeably.

A spatial relation information identifier (ID) (TCI state ID) and spatial relation information (TCI state) may be interchangeably used. “Spatial relation information (TCI state)” may be used interchangeably with “a set of spatial relation information (TCI state)”, “one or a plurality of spatial relation information”, and the like. The TCI state and the TCI may be used interchangeably. The spatial relation information and the spatial relation may be used interchangeably.

In the present disclosure, the terms such as a “base station (BS)”, a “radio base station”, a “fixed station”, a “NodeB”, an “eNB (eNodeB)”, a “qNB (gNodeB)”, an “access point”, a “transmission point (TP)”, a “reception point (RP)”, a “transmission/reception point (TRP)”, a “panel”, a “cell”, a “sector”, a “cell group”, a “carrier”, a “component carrier”, and so on can be used interchangeably. The base station may be referred to as the terms such as a “macro cell”, a “small cell”, a “femto cell”, a “pico cell”, and so on.

A base station can accommodate one or a plurality of (for example, three) cells. When a base station accommodates a plurality of cells, the entire coverage area of the base station can be partitioned into multiple smaller areas, and each smaller area can provide communication services through base station subsystems (for example, indoor small base stations (Remote Radio Heads (RRHs))). The term “cell” or “sector” refers to part of or the entire coverage area of at least one of a base station and a base station subsystem that provides communication services within this coverage.

In the present disclosure, transmitting information to the terminal by the base station may be interchangeably interpreted as instructing the terminal to perform control/operation based on the information by the base station.

In the present disclosure, the terms “mobile station (MS)”, “user terminal”, “user equipment (UE)”, and “terminal” may be used interchangeably.

A mobile station may be referred to as a “subscriber station”, “mobile unit”, “subscriber unit”, “wireless unit”, “remote unit”, “mobile device”, “wireless device”, “wireless communication device”, “remote device”, “mobile subscriber station”, “access terminal”, “mobile terminal”, “wireless terminal”, “remote terminal”, “handset”, “user agent”, “mobile client”, “client”, or some other appropriate terms in some cases.

At least one of a base station and a mobile station may be referred to as a “transmitting apparatus”, a “receiving apparatus”, a “radio communication apparatus” or the like. Note that at least one of a base station and a mobile station may be a device mounted on a moving object or a moving object itself, and so on.

The moving object is a movable object with any moving speed, and naturally, it also includes a moving object stopped. Examples of the moving object include a vehicle, a transport vehicle, an automobile, a motorcycle, a bicycle, a connected car, a loading shovel, a bulldozer, a wheel loader, a dump truck, a fork lift, a train, a bus, a trolley, a rickshaw, a ship and other watercraft, an airplane, a rocket, a artificial satellite, a drone, a multicopter, a quadcopter, a balloon, and an object mounted on any of these, but these are not restrictive. The moving object may be a moving object that autonomously travels based on a direction for moving.

The moving object may be a vehicle (for example, a car, an airplane, and the like), may be a moving object which moves unmanned (for example, a drone, an autonomous car, and the like), or may be a robot (a manned type or unmanned type). Note that at least one of a base station and a mobile station also includes an apparatus which does not necessarily move during communication operation. For example, at least one of a base station and a mobile station may be an Internet of Things (IoT) device such as a sensor.

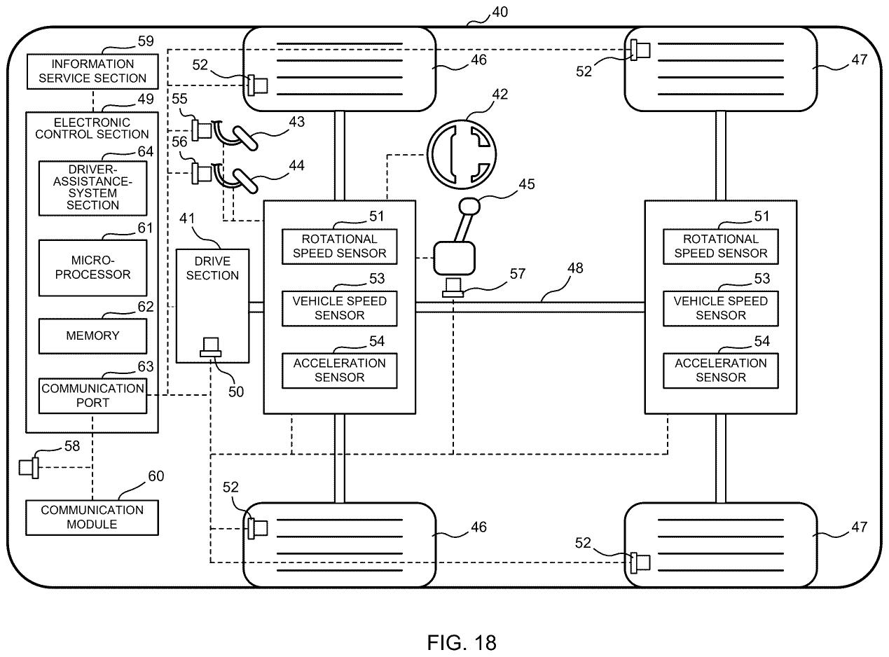

FIG. 18 is a diagram to show an example of a vehicle according to one embodiment. A vehicle 40 includes a drive section 41, a steering section 42, an accelerator pedal 43, a brake pedal 44, a shift lever 45, right and left front wheels 46, right and left rear wheels 47, an axle 48, an electronic control section 49, various sensors (including a current sensor 50, a rotational speed sensor 51, a pneumatic sensor 52, a vehicle speed sensor 53, an acceleration sensor 54, an accelerator pedal sensor 55, a brake pedal sensor 56, a shift lever sensor 57, and an object detection sensor 58), an information service section 59, and a communication module 60.

The drive section 41 includes, for example, at least one of an engine, a motor, and a hybrid of an engine and a motor. The steering section 42 includes at least a steering wheel (also referred to as a handle), and is configured to steer at least one of the front wheels 46 and the rear wheels 47, based on operation of the steering wheel operated by a user.

The electronic control section 49 includes a microprocessor 61, a memory (ROM, RAM) 62, and a communication port (for example, an input/output (IO) port) 63. The electronic control section 49 receives, as input, signals from the various sensors 50 to 58 provided in the vehicle. The electronic control section 49 may be referred to as an Electronic Control Unit (ECU).

Examples of the signals from the various sensors 50 to 58 include a current signal from the current sensor 50 for sensing current of a motor, a rotational speed signal of the front wheels 46/rear wheels 47 acquired by the rotational speed sensor 51, a pneumatic signal of the front wheels 46/rear wheels 47 acquired by the pneumatic sensor 52, a vehicle speed signal acquired by the vehicle speed sensor 53, an acceleration signal acquired by the acceleration sensor 54, a depressing amount signal of the accelerator pedal 43 acquired by the accelerator pedal sensor 55, a depressing amount signal of the brake pedal 44 acquired by the brake pedal sensor 56, an operation signal of the shift lever 45 acquired by the shift lever sensor 57, and a detection signal for detecting an obstruction, a vehicle, a pedestrian, and the like acquired by the object detection sensor 58.

The information service section 59 includes: various devices for providing (outputting) various pieces of information such as driving information, traffic information, and entertainment information, such as a car navigation system, an audio system, a speaker, a display, a television, and a radio; and one or more ECUs that control these devices. The information service section 59 provides various pieces of information/services (for example, multimedia information/multimedia service) to an occupant of the vehicle 40, using information acquired from an external apparatus via the communication module 60 and the like.

The information service section 59 may include an input device (for example, a keyboard, a mouse, a microphone, a switch, a button, a sensor, a touch panel, and the like) for receiving input from the outside, or may include an output device (for example, a display, a speaker, an LED lamp, a touch panel, and the like) for implementing output to the outside.

A driver-assistance-system section 64 includes: various devices for providing functions for preventing an accident and reducing a driver's driving load, such as a millimeter wave radar, Light Detection and Ranging (LiDAR), a camera, a positioning locator (for example, a Global Navigation Satellite System (GNSS) and the like), map information (for example, a high definition (HD) map, an autonomous vehicle (AV) map, and the like), a gyro system (for example, an inertial measurement apparatus (inertial measurement unit (IMU)), an inertial navigation apparatus (inertial navigation system (INS)), and the like), an artificial intelligence (AI) chip, and an AI processor; and one or more ECUS that control these devices. The driver-assistance-system section 64 transmits and receives various pieces of information via the communication module 60, and implements a driving assistance function or an autonomous driving function.

The communication module 60 can communicate with the microprocessor 61 and the constituent elements of the vehicle 40 via the communication port 63. For example, the communication module 60 transmits and receives data (information), via the communication port 63, to and from the drive section 41, the steering section 42, the accelerator pedal 43, the brake pedal 44, the shift lever 45, the right and left front wheels 46, the right and left rear wheels 47, the axle 48, the microprocessor 61 and the memory (ROM, RAM) 62 in the electronic control section 49, and the various sensors 50 to 58, which are included in the vehicle 40.

The communication module 60 is a communication device that can be controlled by the microprocessor 61 of the electronic control section 49 and that can perform communication with an external apparatus. For example, the communication module 60 performs transmission and reception of various pieces of information to and from the external apparatus via radio communication. The communication module 60 may be either inside or outside the electronic control section 49. The external apparatus may be, for example, the base station 10, the user terminal 20, or the like described above. The communication module 60 may be, for example, at least one of the base station 10 and the user terminal 20 described above (may function as at least one of the base station 10 and the user terminal 20).

The communication module 60 may transmit at least one of signals input from the various sensors 50 to 58 to the electronic control section 49, information obtained based on the signals, and information based on an input from the outside (a user) obtained via the information service section 59, to the external apparatus via radio communication. The electronic control section 49, the various sensors 50 to 58, the information service section 59, and the like may be referred to as input sections that receive input. For example, the PUSCH transmitted by the communication module 60 may include information based on the input.

The communication module 60 receives various pieces of information (traffic information, signal information, inter-vehicle distance information, and the like) transmitted from the external apparatus, and displays the received information on the information service section 59 included in the vehicle. The information service section 59 may be referred to as an output section that outputs information (for example, outputs information to devices, such as a display and a speaker, based on the PDSCH received by the communication module 60 (or data/information decoded from the PDSCH)).

The communication module 60 stores the various pieces of information received from the external apparatus in the memory 62 that can be used by the microprocessor 61. Based on the pieces of information stored in the memory 62, the microprocessor 61 may control the drive section 41, the steering section 42, the accelerator pedal 43, the brake pedal 44, the shift lever 45, the right and left front wheels 46, the right and left rear wheels 47, the axle 48, the various sensors 50 to 58, and the like provided in the vehicle 40.

Furthermore, the base station in the present disclosure may be interpreted as a user terminal. For example, each aspect/embodiment of the present disclosure may be applied to the structure that replaces a communication between a base station and a user terminal with a communication between a plurality of user terminals (for example, which may be referred to as “Device-to-Device (D2D)”, “Vehicle-to-Everything (V2X)”, and the like). In this case, user terminals 20 may have the functions of the base stations 10 described above. The words such as “uplink” and “downlink” may be interpreted as the words corresponding to the terminal-to-terminal communication (for example, “sidelink”). For example, an uplink channel, a downlink channel and so on may be interpreted as a sidelink channel.

Likewise, the user terminal in the present disclosure may be interpreted as a base station. In this case, the base station 10 may have the functions of the user terminal 20 described above.

Operations which have been described in the present disclosure to be performed by a base station may, in some cases, be performed by an upper node of the base station. In a network including one or a plurality of network nodes with base stations, it is clear that various operations that are performed to communicate with terminals can be performed by base stations, one or more network nodes (for example, Mobility Management Entities (MMEs), Serving-Gateways (S-GWs), and so on may be possible, but these are not limiting) other than base stations, or combinations of these.

Each aspect/embodiment described in the present disclosure may be used independently, may be used in combination, or may be switched depending on the mode of implementation. The order of processes, sequences, flowcharts, and so on that have been used to describe the aspects/embodiments in the present disclosure may be re-ordered as long as inconsistencies do not arise. For example, although various methods have been illustrated in the present disclosure with various components of steps in exemplary orders, the specific orders that are illustrated herein are by no means limiting.

The aspects/embodiments illustrated in the present disclosure may be applied to Long Term Evolution (LTE), LTE-Advanced (LTE-A), LTE-Beyond (LTE-B), SUPER 3G, IMT-Advanced, 4th generation mobile communication system (4G), 5th generation mobile communication system (5G), 6th generation mobile communication system (6G), xth generation mobile communication system (xG (where x is, for example, an integer or a decimal)), Future Radio Access (FRA), New-Radio Access Technology (RAT), New Radio (NR), New radio access (NX), Future generation radio access (FX), Global System for Mobile communications (GSM (registered trademark)), CDMA 2000, Ultra Mobile Broadband (UMB), IEEE 802.11 (Wi-Fi (registered trademark)), IEEE 802.16 (WiMAX (registered trademark)), IEEE 802.20, Ultra-WideBand (UWB), Bluetooth (registered trademark), systems that use other adequate radio communication methods and next-generation systems that are enhanced, modified, created, or defined based on these. A plurality of systems may be combined (for example, a combination of LTE or LTE-A and 5G, and the like) for application.

The phrase “based on” (or “on the basis of”) as used in the present disclosure does not mean “based only on” (or “only on the basis of”), unless otherwise specified. In other words, the phrase “based on” (or “on the basis of”) means both “based only on” and “based at least on” (“only on the basis of” and “at least on the basis of”).

Reference to elements with designations such as “first”, “second”, and so on as used in the present disclosure does not generally limit the quantity or order of these elements. These designations may be used in the present disclosure only for convenience, as a method for distinguishing between two or more elements. Thus, reference to the first and second elements does not imply that only two elements may be employed, or that the first element must precede the second element in some way.

The term “deciding (determining)” as in the present disclosure herein may encompass a wide variety of actions. For example, “deciding (determining)” may be interpreted to mean making “decisions (determinations)” about judging, calculating, computing, processing, deriving, investigating, looking up, search and inquiry (for example, searching a table, a database, or some other data structures), ascertaining, and so on.

Furthermore, “deciding (determining)” may be interpreted to mean making “decisions (determinations)” about receiving (for example, receiving information), transmitting (for example, transmitting information), input, output, accessing (for example, accessing data in a memory), and so on.

In addition, “deciding (determining)” as used herein may be interpreted to mean making “decisions (determinations)” about resolving, selecting, choosing, establishing, comparing, and so on. In other words, “deciding (determining)” may be interpreted to mean making “decisions (determinations)” about some action. In the present disclosure, “decide/deciding (determine/determining)” may be interchangeably interpreted as the above-described actions.

In the Present Disclosure, “decide/deciding (determine/determining)” may be used interchangeably with “assume/assuming”, “expect/expecting”, “consider/considering”, and the like. Note that, in the present disclosure, “not expect to” may be used interchangeably with “expect not to”.

In the present disclosure, “expect” may be used interchangeably with “be expected”. For example, “expect(s) . . . ” (“ . . . ” may be expressed using, for example, a that-clause, a to-infinitive, or the like) may be used interchangeably with “be expected . . . ”. “Does not expect . . . ” may be used interchangeably with “be not expected . . . ”. Furthermore, “an apparatus A is not expected . . . ” may be used interchangeably with “an apparatus B other than the apparatus A does not expect . . . for the apparatus A” (for example, when the apparatus A is a UE, the apparatus B may be a base station).

“The maximum transmit power” described in the present disclosure may mean a maximum value of the transmit power, may mean the nominal maximum transmit power (the nominal UE maximum transmit power), or may mean the rated maximum transmit power (the rated UE maximum transmit power).

The terms “connected”, “coupled”, or any variation of these terms as used in the present disclosure mean any direct or indirect connections or coupling between two or more elements, and may include the presence of one or more intermediate elements between two elements that are “connected” or “coupled” to each other. The coupling or connection between the elements may be physical, logical, or a combination thereof. For example, “connection” may be interpreted as “access”.

In the present disclosure, when two elements are connected, the two elements may be considered “connected” or “coupled” to each other by using one or more electrical wires, cables and printed electrical connections, and, as some non-limiting and non-inclusive examples, by using electromagnetic energy having wavelengths in radio frequency regions, microwave regions, (both visible and invisible) optical regions, or the like.

In the present disclosure, the phrase “A and B are different” may mean that “A and B are different from each other”. It should be noted that the phrase may mean that “A and B are each different from C”. The terms “separate”, “coupled”, and so on may be interpreted similarly to “different”.

In the case where the terms “include”, “including”, and variations thereof are used in the present disclosure, these terms are intended to be comprehensive, in a manner similar to the term “comprising”. Furthermore, the term “or” used in the present disclosure is not intended to be an “exclusive or”.

For example, in the present disclosure, where an article such as “a”, “an”, and “the” is added by translation, the present disclosure may include that a noun after the article is in a plural form.

In the present disclosure, “equal to or less than”, “less than”, “equal to or more than”, “more than”, “equal to”, and the like may be used interchangeably. In the present disclosure, words such as “good”, “bad”, “large”, “small”, “high”, “low”, “early”, “late”, “wide”, “narrow”, and the like may be used interchangeably irrespective of positive degree, comparative degree, and superlative degree. In the present disclosure, expressions obtained by adding “i-th” (i is any integer) to words such as “good”, “bad”, “large”, “small”, “high”, “low”, “early”, “late”, “wide”, “narrow”, and the like may be used interchangeably irrespective of positive degree, comparative degree, and superlative degree (for example, “best” may be used interchangeably with “i-th best”, and vice versa).

In the present disclosure, “of”, “for”, “regarding”, “related to”, “associated with”, and the like may be used interchangeably.

In the present disclosure, “when A, B”, “if A, (then) B”, “B upon A”, “B in response to A”, “B based on A”, “B during/while A”, “B before A”, “B (at the same time as) /on A”, “B after A”, “B since A”, “B until A”, and the like may be used interchangeably. Note that A and B here may be replaced with appropriate expressions such as nouns, dynamic nouns, and normal sentences, as appropriate, depending on the context. The time difference between A and B may be substantially 0 (immediately after or immediately before). A time offset may be applied to the time at which A occurs. For example, “A” may be used interchangeably with “before/after the time offset at which A occurs”. The time offset (for example, one or more symbols/slots) may be defined in advance or may be specified by the UE based on the notified information.

In the present disclosure, timing, time point, time, time instance, any time unit (e.g., slot, sub-slot, symbol, subframe), period, occasion, a resource, or the like may be used interchangeably.

Now, although the invention according to the present disclosure has been described in detail above, it is apparent to a person skilled in the art that the invention according to the present disclosure is by no means limited to the embodiments described in the present disclosure. The description of the present disclosure is provided only for the purpose of explaining examples, and should by no means be construed to limit the invention according to the present disclosure in any way.

1.-6. (canceled)

7. A terminal comprising:
a receiver that receives information related to a candidate cell for which cell switching by L1/L2 signaling is supported; and
a processor that controls measurement of the candidate cell,
wherein with respect to at least one of intra-frequency measurement and inter-frequency measurement, a plurality of parameters related to a synchronization signal block (SSB) is configured for each candidate cell.

8. The terminal according to claim 7, wherein a specific parameter of the plurality of parameters related to the SSB is a parameter related to an SSB measurement timing and is same between the intra-frequency measurement and the inter-frequency measurement.

9. The terminal according to claim 7, wherein a frequency domain location parameter of the plurality of parameters related to the SSB is different between the intra-frequency measurement and the inter-frequency measurement.

10. A radio communication method for a terminal, comprising:
receiving information related to a candidate cell for which cell switching by L1/L2 signaling is supported; and
controlling measurement of the candidate cell,
wherein with respect to at least one of intra-frequency measurement and inter-frequency measurement, a plurality of parameters related to a synchronization signal block (SSB) is configured for each candidate cell.

11. A base station comprising:
a transmitter that transmits, to a terminal, information related to a candidate cell for which cell switching by L1/L2 signaling is supported; and
a processor that indicates measurement of the candidate cell in the terminal,
wherein with respect to at least one of intra-frequency measurement and inter-frequency measurement, a plurality of parameters related to a synchronization signal block (SSB) is configured for each candidate cell.

12. A system comprising a terminal and a base station, wherein
the terminal comprises:
a receiver that receives information related to a candidate cell for which cell switching by L1/L2 signaling is supported; and
a processor that controls measurement of the candidate cell,
wherein with respect to at least one of intra-frequency measurement and inter-frequency measurement, a plurality of parameters related to a synchronization signal block (SSB) is configured for each candidate cell, and
the base station comprises:
a transmitter that transmits the information to the terminal; and
a processor that indicates the measurement of the candidate cell in the terminal.
